(19) United States
(12) Patent Application Publication
(10) Pub. No.: US 2026/0289195 A1
(43) Pub. Date: Sep. 24, 2026

(54) SYSTEM

(71) Applicant: SoftBank Group Corp., Tokyo (JP)

(72) Inventor: Tomoya OGATA, Tokyo (JP)

(73) Assignee: SoftBank Group Corp., Tokyo (JP)

(21) Appl. No.: 19/561,809

(22) Filed: Mar. 10, 2026

(30) Foreign Application Priority Data
Mar. 19, 2025 (JP) 2025-044492

(51) Int. Cl. G06F 40/58; G06F 16/3329; G06F 40/174; G06F 40/186; G06F 40/284; G06F 40/295; G06F 40/30; G10L 15/01; G10L 15/04; G10L 15/16; G10L 25/24; G10L 25/63

(52) U.S. Cl. CPC G06F 40/58; G06F 16/3329; G06F 40/174; G06F 40/186; G06F 40/284; G06F 40/295; G06F 40/30; G10L 15/01; G10L 15/04; G10L 15/16; G10L 25/24; G10L 25/63

(57) ABSTRACT

A system includes a processor that is configured to collect audio data using a microphone to acquire utterances of meeting participants, convert the collected audio data into text data in a plurality of languages using an acoustic model and a language model, and analyze the text data and generate a prompt for instructing a generative AI model to automatically generate minutes, and cause the generative AI model to perform at least highlighting of important points and summaries of discussions and proposing action items.

### CROSS-REFERENCE TO RELATED APPLICATION

This application is based on and claims priority under 35 USC 119 from Japanese Patent Application No. 2025-044492 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional meeting support systems, automatic generation of meeting minutes often relies solely on simple speech-to-text conversion without leveraging advanced generative AI models for structuring and enriching the content. As a result, such systems frequently produce raw or unorganized transcripts that do not clearly highlight important points, summarize discussions, or propose actionable tasks, thereby imposing additional manual effort on users after the meeting. Furthermore, conventional systems typically do not incorporate users' emotional states into the generation of minutes or summaries. Consequently, nuances such as urgency, disagreement, or strong approval expressed in participants' voices are not reflected in the meeting minutes or in the proposed action items. This lack of emotional context can lead to incomplete understanding of the discussion dynamics, mis-prioritization of tasks, and reduced effectiveness of decision-making support. Therefore, there is a need for a system that not only collects and recognizes speech in multiple languages and generates meeting minutes using a generative AI model, but also recognizes user emotions from audio data and utilizes the emotion information to adjust prompts to the generative AI model. Such a system should be capable of producing minutes, summaries, and action items that more accurately reflect the content and emotional context of the meeting, thereby reducing post-meeting workload and improving the quality and usefulness of the generated outputs.

### SUMMARY

In order to solve the above-described problems, a system according to one aspect of the present invention comprises a processor configured to collect audio data using a microphone to acquire utterances of meeting participants, convert the collected audio data into text data in a plurality of languages using an acoustic model and a language model, and analyze the text data and generate a prompt for instructing a generative AI model to automatically generate minutes, and cause the generative AI model to perform at least highlighting of important points and summaries of discussions and proposing action items. In addition, the processor is configured to extract audio features from the audio data, recognize an emotion of a user using a machine learning model based on the audio features, and provide emotion information representing the emotion to the generative AI model. Furthermore, the processor is configured to adjust the prompt based on the provided emotion information so as to instruct the generative AI model to create minutes and summaries of discussions based on the emotion information, and cause the generative AI model to propose action items based on the emotion information. By combining multilingual speech recognition, generative AI-based document generation, and emotion recognition from audio, the system can generate meeting minutes, discussion summaries, and action items that capture both the factual content and the emotional context of the meeting, thereby reducing the burden on users and enhancing the accuracy, clarity, and practical value of the generated outputs.

The term “processor” refers to one or more hardware processing units, such as a central processing unit (CPU), graphics processing unit (GPU), digital signal processor (DSP), or other computing circuitry, and may further include associated memory and control logic configured to execute instructions to perform the claimed functions.

The term “microphone” refers to a hardware device configured to convert sound waves, including speech of meeting participants, into corresponding electrical signals or digital audio data that can be processed by the processor.

The term “audio data” refers to data representing sound, including analog or digital representations of speech signals captured by one or more microphones, which can be further processed for speech recognition, feature extraction, and emotion recognition.

The term “utterances of meeting participants” refers to spoken words, phrases, and sentences produced by individuals taking part in a meeting, including questions, comments, opinions, and other verbal contributions.

The term “acoustic model” refers to a machine learning model or statistical model that represents the relationship between audio features extracted from speech signals and corresponding phonetic or linguistic units, and is used by the processor to support conversion of audio data into text data.

The term “language model” refers to a model, such as a statistical language model or a neural network-based model, that represents probabilities or patterns of word sequences in a given language, and is used by the processor to improve the accuracy and fluency of text conversion and generation.

The term “plurality of languages” refers to two or more natural languages, such as English, Japanese, or other human languages, for which the processor is capable of performing speech recognition and generating corresponding text data.

The term “text data” refers to a sequence of characters, tokens, or words representing the linguistic content recognized from audio data, which can be analyzed and used as input to a generative AI model.

The term “analyze the text data” refers to processing the text data to extract information such as topics, entities, relationships, discourse structure, and other contextual or semantic features, which are used to generate prompts or other control signals for a generative AI model.

The term “prompt” refers to information, including text, parameters, or structured data, generated by the processor and provided as input to a generative AI model to specify or guide the content, style, or structure of outputs such as minutes, summaries, highlights, and action items.

The term “generative AI model” refers to a machine learning model, such as a large language model or other generative model, that is configured to produce natural language text or other content based on input prompts and context information provided by the processor.

The term “minutes” refers to a structured document that records the content of a meeting, including at least topics discussed, statements made by participants, decisions, and other relevant information, and that is automatically generated by the generative AI model based on instructions from the processor.

The term “highlighting of important points” refers to emphasizing or marking specific information in the generated content that the generative AI model determines to be of particular relevance, such as key decisions, critical issues, or main conclusions of the meeting.

The term “summaries of discussions” refers to condensed textual descriptions of one or more portions of a meeting, generated by the generative AI model, that capture the main ideas, arguments, or outcomes of the discussions in a shorter and more easily understandable form.

The term “action items” refers to tasks, responsibilities, follow-up actions, or obligations derived from the meeting content, including optionally associated assignees and deadlines, that are proposed or identified by the generative AI model.

The term “audio features” refers to numerical or symbolic representations derived from audio data, such as spectral coefficients, prosodic features, pitch, energy, speaking rate, or other characteristics used for speech recognition or emotion recognition.

The term “machine learning model” refers to a model trained on data using one or more machine learning techniques, such as deep neural networks, support vector machines, or ensemble methods, and configured to perform tasks including emotion recognition based on audio features.

The term “emotion of a user” refers to an affective state of a meeting participant, such as happiness, sadness, anger, neutrality, excitement, or other emotional categories or dimensions, which is inferred by the machine learning model from audio features.

The term “emotion information” refers to data representing one or more emotional states recognized for a user, including, for example, emotion labels, confidence scores, or intensity values, which is provided by the processor to the generative AI model.

The term “adjust the prompt” refers to modifying content, parameters, or structure of a prompt provided to the generative AI model, based at least in part on emotion information, to influence the generation of minutes, summaries, highlights, or action items so that they reflect emotional context.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

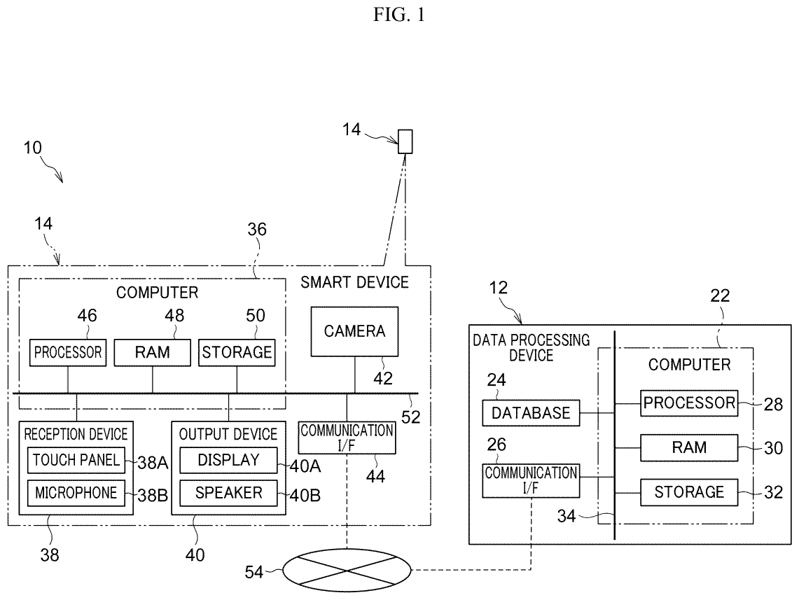

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

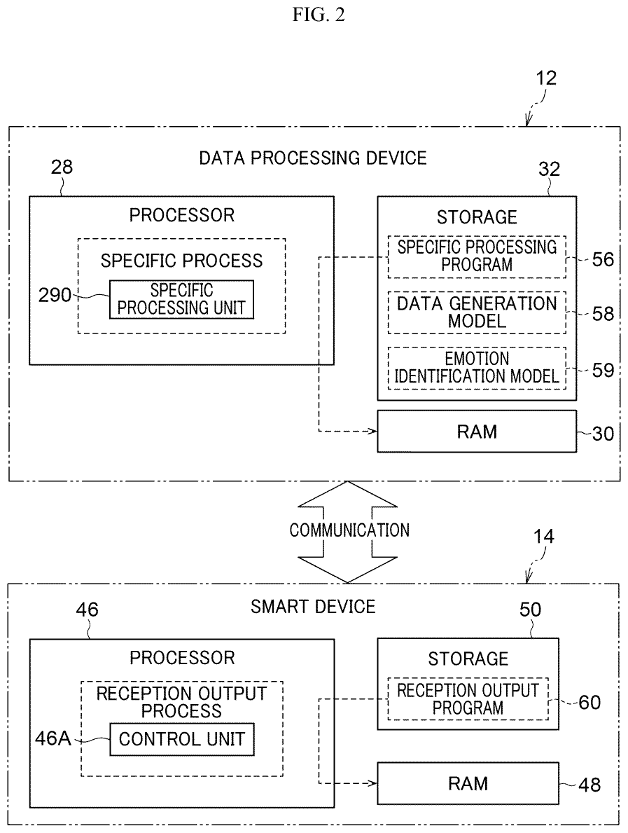

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented meeting support systems that record and transcribe meetings suffer from multiple technical limitations that reduce their effectiveness and increase processing overhead. First, typical systems simply convert audio to text and store a linear transcript. Such systems require a human operator to manually read long, unstructured transcripts and to extract summaries, decisions, and action items, which leads to inefficient utilization of computing resources and increased interaction cycles between the user and the system. The processor primarily acts as a passive recorder, and the overall human-computer workflow remains cumbersome and time-consuming.

Second, existing systems that employ speech recognition engines are generally designed to output text at the utterance level without maintaining a structured, time-aligned representation that is organized according to meeting progress, such as per agenda item or time segment. As a result, downstream processing modules cannot efficiently identify context boundaries, agenda transitions, or key discussion segments. This unstructured handling of recognized text forces additional post-processing, increases memory accesses for repeated scanning of large text buffers, and degrades the responsiveness and scalability of the system when deployed on shared computing resources.

Third, while generative artificial intelligence models have emerged as powerful tools for generating natural language summaries, conventional integrations with such models are rudimentary. Typical implementations submit raw or minimally processed transcripts to a generative model as a monolithic prompt. This approach leads to non-optimal use of the model's token capacity, redundant transmission of large amounts of text data, and increased latency. The system fails to exploit the temporal structure and update patterns of an ongoing meeting, making it difficult to generate minutes incrementally and in near real time. Moreover, naive prompting strategies do not systematically incorporate meeting metadata, user-intended formatting, or contextual constraints, leading to inconsistent quality of generated minutes and inefficient iterations between the user and the system.

Fourth, existing systems rarely integrate automatic emotion recognition from the audio signal into the meeting minutes generation pipeline. Even when emotional information is available, it is not effectively fed back into the prompt design or the control logic of the generative model. Consequently, the system cannot dynamically adjust highlighting of important points, emphasis levels, or the granularity and tone of proposed action items based on detected emotional states of participants. This results in a rigid and context-insensitive generation process, in which the processor does not fully leverage multimodal data to optimize the generation of meeting artifacts.

Fifth, conventional systems often treat user edits of automatically generated minutes merely as final corrections, without using them as structured feedback for subsequent processing cycles. Edited minutes are stored as separate documents, and the system does not systematically link them back to the underlying transcript structure or to future prompt generation strategies. This prevents the system from adaptively improving its behavior across multiple meetings and leads to repeated computational waste, as similar errors reoccur and must be corrected manually each time.

Accordingly, there is a need for an improved computer-implemented meeting processing system in which a processor: (i) acquires and recognizes meeting audio in a way that produces structured, time-aligned character information; (ii) manages this information as agenda-based or time-based meeting-record text; (iii) automatically generates optimized prompt sentences that efficiently guide a generative information processing model; (iv) incorporates emotion recognition results into the prompt and control flow; and (v) uses user-edited minutes as reference information to improve subsequent prompt generation and action-item proposals. By addressing these technical challenges, the invention can reduce computational overhead, improve response time and scalability, and enhance the consistency and context-awareness of computer-generated meeting minutes.

The specific processing by the specific processing unit 290 of the data processing device 12 in Example 1 is realized by the following means.

The present invention provides a server comprising a processor configured to acquire audio information of utterances of meeting participants via an audio acquisition unit including an audio input device, convert the acquired audio information into character information in a plurality of languages through a speech recognition unit that supports multilingual recognition, manage the character information by a text management unit that accumulates the character information in time series order and generates meeting-record text on an agenda basis or on a time-segment basis in accordance with progress of a meeting, generate by a prompt generation unit a prompt sentence including the meeting-record text and instruction content regarding a summary of the meeting, decision items, action items, and a document format, transmit by a generation instruction unit the prompt sentence to a generative information processing model disposed externally or internally so as to cause the generative information processing model to generate a minutes document based on the meeting-record text sequentially or at predetermined intervals, store and update by a minutes management unit the minutes document in accordance with the progress of the meeting and transmit the minutes document to a display device or an output device, extract by an emotion recognition unit feature values from the audio information and estimate an emotional state of at least one of the meeting participants by using a trained discrimination model, and provide by a prompt adjustment unit the estimated emotional state to the prompt generation unit so as to adjust content of the prompt sentence in accordance with the emotional state and thereby control emphasis of important points, summary granularity, and proposals of action items, and further configured to accept by the minutes management unit an editing operation of the minutes document by a user, store an edited minutes document in association with the text management unit as reference information for future prompt sentence generation, and cause subsequent prompt sentences and generated minutes to be improved on the basis of the stored reference information. This enables the server to implement an integrated and technically improved meeting processing pipeline in which audio acquisition, multilingual speech recognition, structured text management, emotion-aware prompt generation, and adaptive use of user edits cooperate to reduce redundant computation, optimize use of generative model resources, support incremental and final minutes generation with lower latency, and improve the accuracy and contextual relevance of computer-generated meeting summaries, decisions, and action-item proposals.

The term “audio acquisition unit” refers to a functional unit, implemented by hardware, software, or a combination thereof, that obtains audio information representing utterances of meeting participants by using at least one audio input device and supplies the obtained audio information to subsequent processing units.

The term “audio input device” refers to a physical input device, such as a microphone or an array microphone, that converts sound waves generated by utterances of meeting participants into electrical signals or digital audio data.

The term “audio information” refers to data representing sound, including analog audio signals and digital audio signals, that contain acoustic characteristics of utterances of meeting participants and are suitable for speech recognition processing.

The term “speech recognition unit” refers to a functional unit, implemented by hardware, software, or a combination thereof, that analyzes audio information to generate corresponding character information by using one or more speech recognition models.

The term “multilingual recognition” refers to processing by which a speech recognition unit supports conversion of audio information into character information in a plurality of different natural languages, based on acoustic and language models for each of the different languages.

The term “character information” refers to symbol data representing recognized linguistic content of utterances in a machine-readable text form, including letters, punctuation marks, and other textual symbols.

The term “text management unit” refers to a functional unit, implemented by hardware, software, or a combination thereof, that stores character information in a memory, maintains the character information in time series order, and generates structured meeting-record text based on agenda divisions or time segments.

The term “time series order” refers to an order of data elements arranged according to occurrence time, such that character information is stored or processed in the sequence in which corresponding utterances occurred during a meeting.

The term “meeting-record text” refers to structured text data derived from accumulated character information, in which utterances are organized by agenda item, time segment, or other meeting-context units suitable for generating minutes.

The term “agenda basis” refers to a manner of organizing meeting-record text in units corresponding to agenda items or topics that are planned or actually discussed during a meeting.

The term “time-segment basis” refers to a manner of organizing meeting-record text into units defined by temporal ranges within a meeting, such as fixed-length intervals or time spans corresponding to specific discussion phases.

The term “prompt generation unit” refers to a functional unit, implemented by hardware, software, or a combination thereof, that constructs a prompt sentence to be input to a generative information processing model by combining meeting-record text with instruction content specifying a desired output, format, or emphasis.

The term “prompt sentence” refers to text data supplied as input to a generative information processing model, including one or more instructions, contextual information, and meeting-record text, and used to control or condition generation of a minutes document.

The term “instruction content” refers to text included in a prompt sentence that specifies requirements for the generative information processing model, such as summarization, identification of decision items, extraction of action items, language of output, and document formatting rules.

The term “generation instruction unit” refers to a functional unit, implemented by hardware, software, or a combination thereof, that transmits a prompt sentence to a generative information processing model and controls timing, frequency, and conditions under which the generative information processing model generates a minutes document.

The term “generative information processing model” refers to a computational model, such as a generative AI model based on machine learning, that receives a prompt sentence as input and outputs generated natural language text representing at least part of a minutes document.

The term “minutes document” refers to text data expressing a record of a meeting, including at least one of a summary, discussion points, decision items, and action items, and generated in whole or in part by a generative information processing model.

The term “minutes management unit” refers to a functional unit, implemented by hardware, software, or a combination thereof, that stores and updates a minutes document in accordance with meeting progress, manages versions of the minutes document, and controls transmission of the minutes document to a display device or an output device.

The term “display device” refers to an output device, such as a monitor, a tablet display, or a smartphone display, that visually presents a minutes document or related information to a user.

The term “output device” refers to a device that outputs a minutes document in a non-transient form or through another medium, including a printer, a storage device, or a communication interface for transmitting the minutes document to an external system.

The term “emotion recognition unit” refers to a functional unit, implemented by hardware, software, or a combination thereof, that extracts feature values from audio information and estimates an emotional state of at least one meeting participant by using a trained discrimination model.

The term “feature values” refers to numerical values or vectors derived from audio information, such as spectral characteristics, prosodic parameters, and temporal patterns, that are used as inputs to a discrimination model for emotion recognition.

The term “trained discrimination model” refers to a model obtained by machine learning or statistical training that maps feature values extracted from audio information to one or more classes or parameters representing emotional states.

The term “emotional state” refers to information indicating affective characteristics of a meeting participant, such as levels or categories of neutrality, happiness, frustration, urgency, or other emotional attributes inferred from audio information.

The term “prompt adjustment unit” refers to a functional unit, implemented by hardware, software, or a combination thereof, that modifies or supplements a prompt sentence based on an estimated emotional state, thereby controlling emphasis of important points, summary granularity, or proposals of action items.

The term “summary granularity” refers to a level of detail in a generated summary, such as a high-level abstract summary, an intermediate-level outline, or a detailed description of discussion content.

The term “action items” refers to tasks or follow-up activities identified from meeting content, including information about responsible persons, required actions, and, optionally, deadlines or conditions.

The term “decision items” refers to statements or records of resolutions, agreements, or determinations reached during a meeting, including final choices among alternatives or confirmations of prior decisions.

The term “reference information” refers to stored data, including edited minutes documents and associated context, that is used by the server to influence or improve future prompt sentence generation or minutes generation.

The term “edited minutes document” refers to a minutes document that has been modified by a user through an editing operation after initial generation by a generative information processing model.

The term “server” refers to an electronic computing apparatus, including at least one processor and at least one memory, that executes programs implementing the audio acquisition, speech recognition, text management, prompt generation, generation instruction, minutes management, emotion recognition, and prompt adjustment units, and that communicates with one or more terminals or external services over a communication network.

In one embodiment, a server, a terminal, and a network-connected audio input/output environment cooperate to implement the invention. The server includes at least one processor, a main memory, a non-transitory storage device, and a communication interface. The terminal includes at least one processor, a memory, a display device, and one or more audio input devices such as microphones. The server and the terminal communicate via a wired or wireless communication network.

The server executes a meeting-processing program stored in the storage device. The terminal executes a client program, for example a web browser or a dedicated native application. The user operates the terminal to start, monitor, and finalize a meeting session.

The terminal uses a microphone as the audio input device. The microphone converts analog sound waves representing utterances of meeting participants into electrical signals. The terminal uses an operating system audio subsystem, such as Windows WASAPI, ALSA on Linux, or CoreAudio on macOS, to sample and digitize the electrical signals into digital audio information, for example 16-bit PCM data at a sampling rate of 16 kHz. The terminal buffers the digital audio information in frames and transmits the audio information to the server via the communication interface using a transport protocol such as HTTPS or WebSocket.

The server receives the digital audio information and stores the audio information in a buffer in the main memory. The server also optionally stores the audio information in a storage device, for example a disk array or network storage. The server associates the audio information with a session identifier, a timestamp, and optional metadata such as speaker identifiers or meeting identifiers.

The server includes an audio acquisition unit implemented as a software module executed by the processor. The audio acquisition unit manages communication with the terminal, receives the audio information, and provides the audio information to a speech recognition unit.

The server includes the speech recognition unit implemented as a software module that uses at least one speech recognition engine. The speech recognition unit may employ a deep neural network acoustic model and a language model. In one example, the server uses a cloud-based speech recognition service accessible through an application programming interface, such as a generic speech-to-text API, which internally may be implemented using a recurrent neural network or a transformer-based acoustic model and an n-gram or neural language model. Alternatively, the server may use a locally installed speech recognition library.

The speech recognition unit normalizes the digital audio information, extracts acoustic features such as Mel-frequency cepstral coefficients (MFCCs), log-mel filterbank energies, or spectrogram frames, and inputs sequences of feature vectors into the acoustic model. The acoustic model outputs posterior probabilities for phonetic units or subword units. The speech recognition unit then uses a decoding algorithm, such as beam search with a language model, to determine the most probable sequence of text tokens. The language model may be a statistical n-gram model or a neural language model implemented by a recurrent neural network or a transformer network, trained on multilingual text data.

The server converts the recognized tokens into character information, for example Unicode-based text in one or more natural languages. The speech recognition unit supports multilingual recognition by selecting an appropriate acoustic model and language model based on language codes indicated for the meeting, or by using a unified multilingual model that outputs language-specific token sequences. The character information includes recognized words, punctuation, and confidence scores.

The server includes a text management unit implemented as a software module executed by the processor. The text management unit receives the character information from the speech recognition unit and stores the character information in a time series order in a text buffer data structure. The text management unit assigns each text segment an identifier, start time, end time, and, optionally, an agenda identifier. The text management unit can use a data structure such as a table or a list of records, where each record includes fields for time range, speaker label, language tag, and text content.

The text management unit organizes the character information into meeting-record text. The meeting-record text is segmented either on an agenda basis or on a time-segment basis. On an agenda basis, the text management unit associates portions of the character information with agenda identifiers obtained from user input or inferred from characteristic phrases such as “Move to the next agenda.” On a time-segment basis, the text management unit groups character information in fixed-length intervals, for example every 60 seconds, or in dynamic intervals based on changes in topic detected by simple lexical similarity measures or predetermined rules.

The server includes an emotion recognition unit implemented as a software module. The emotion recognition unit obtains audio information from the audio acquisition unit or from the stored audio buffer. The emotion recognition unit computes feature values such as pitch contour, energy envelope, spectral centroid, speaking rate, and voice quality indicators. The emotion recognition unit forms feature vectors over time windows, for example 1-second segments with overlap.

The emotion recognition unit includes a trained discrimination model. In one embodiment, the discrimination model is a neural network comprising multiple fully connected layers with non-linear activation functions, or a recurrent network such as a long short-term memory (LSTM) network, or a convolutional network operating on spectrogram-like features. The discrimination model has been trained in advance on labeled audio data where each training sample is associated with an emotional state category such as neutral, positive, negative, urgent, or stressed. The training uses supervised learning with a loss function such as cross-entropy, and parameters are updated by gradient descent-based optimization, such as stochastic gradient descent or Adam. During training, the server may perform data augmentation on audio, such as time stretching, pitch shifting, and additive noise, to improve robustness.

At runtime, the emotion recognition unit feeds the feature vectors into the discrimination model and obtains, for each time window, probability values for each emotional state category. The emotion recognition unit selects an emotional state based on the maximum probability or by applying a threshold rule. The emotion recognition unit may compute a smoothed emotional trajectory by averaging probabilities over multiple consecutive windows to reduce noise. The emotion recognition unit associates the estimated emotional state with corresponding time ranges and, optionally, with speaker identifiers.

The server includes a prompt generation unit implemented as a software module. The prompt generation unit constructs a prompt sentence to be input to a generative AI model, which is an example of a generative information processing model. The prompt generation unit retrieves the relevant meeting-record text from the text management unit. The prompt generation unit also retrieves user-defined or system-defined instruction content, such as a requirement to generate a summary in a specified language, to list decision items, and to propose action items.

The prompt generation unit further receives emotional state information from the emotion recognition unit. The prompt generation unit modifies or supplements the prompt sentence based on the emotional state. For example, if the emotional state indicates high urgency or conflict, the prompt generation unit inserts instructions to highlight contentious points or to propose more detailed action items to resolve identified issues.

In one example, the prompt generation unit constructs a prompt sentence as follows:
“You are a generative AI model that creates structured meeting minutes.
Below is the transcript of an ongoing meeting.
Please update the minutes by adding the latest discussion, and summarize key points, decisions, and action items.
Output in Japanese.
Transcript:
“[latest meeting-record text]”

In another example, for a multilingual meeting, the prompt generation unit constructs:
“You are a generative AI model that handles multilingual input.
The following transcript contains both Japanese and English utterances.
Please produce Japanese meeting minutes that accurately reflect the content, including agenda items, major discussion points, decisions, and action items.
Transcript:
“[multilingual meeting-record text]”

In a further example, for a final version, the prompt generation unit constructs:
“You are a generative AI model specialized in writing professional meeting minutes.
Here is the complete transcript of a meeting.
Please create a final, well-structured minutes document.
Include:
   A brief summary of the meeting
   Agenda items
   Discussion points
   Final decisions
   Action items (with responsible persons and deadlines if mentioned)
Transcript:
“[full meeting-record text]”

The server includes a generation instruction unit that manages communication with the generative AI model. The generative AI model may be provided by an external service accessible via a network API, for example a transformer-based large language model similar to a GPT-type model, or may be deployed locally on the server. The generation instruction unit formats the prompt sentence as a request message, sends the request to the generative AI model, and receives generated text as a response.

The generative AI model may be a transformer network comprising multiple self-attention layers, feedforward layers, and layer normalization layers, trained on large-scale text corpora using a language modeling objective such as next-token prediction. During inference, the model receives the prompt sentence tokenized into subword units and computes contextual embeddings via attention mechanisms. The model outputs probability distributions over tokens, and the generation instruction unit selects tokens using sampling methods such as greedy decoding, beam search, or nucleus sampling. Temperature parameters and maximum token length are set by the generation instruction unit to balance diversity and determinism in the output.

The server includes a minutes management unit implemented as a software module. The minutes management unit receives the generated text, interprets it as a minutes document or a part thereof, and stores the minutes document in structured form. For example, the minutes management unit can store the minutes document as entries in a database, with fields for summary, agenda sections, decisions, and action items. The minutes management unit associates each generated version with a timestamp and a version identifier.

The minutes management unit updates the minutes document as the meeting progresses. When the generation instruction unit obtains updated generated text, the minutes management unit merges the new text with existing minutes. The minutes management unit may replace an entire previous version or update only specific sections, such as adding content to the latest agenda segment. The minutes management unit transmits the updated minutes document to the terminal, which displays the minutes on the display device. The terminal may highlight newly added or modified portions by using different colors or markers.

The user views the minutes on the terminal and can edit the minutes document. The terminal provides a user interface that allows the user to select sentences, correct errors, change structure, or add missing items. The terminal sends edited contents back to the server. The minutes management unit stores the edited minutes document and associates it with the corresponding meeting-record text and generation parameters. The edited document becomes reference information for future prompt sentence generation.

The server uses the reference information to improve future processing. For example, the prompt generation unit may analyze differences between the generated minutes and the edited minutes to adjust instruction content, such as instructing the generative AI model to use specific terminology, to compress or expand certain sections, or to format action items in a particular style. The server may derive rules or patterns, such as consistent correction of certain phrases, and incorporate such rules into subsequent prompts. This feedback mechanism allows the system to adjust the operational parameters of the generation instruction and prompt structure, thereby improving the accuracy and consistency of generated minutes across multiple meetings without retraining the generative AI model.

The described configuration provides technical improvements beyond simple automation of human tasks. By structuring character information as time-aligned meeting-record text, the text management unit reduces the need for repeated scanning of long linear transcripts and enables efficient partial updates. The server can target only the newly added segments when constructing prompt sentences, thereby reducing the length of input to the generative AI model, lowering communication load, and improving processing speed. The combination of agenda-based or time-segment-based segmentation and incremental prompting significantly reduces token usage and memory consumption in the generative model.

By integrating emotion recognition at the audio level, the server enriches the internal representation of meeting context. The emotion recognition unit provides quantitative emotional state information that the prompt adjustment unit uses to change the emphasis and summarization strategy in a deterministic manner. For example, the server can uniformly increase the level of detail and the number of proposed action items for segments where the emotional state indicates conflict or high urgency. This rule-based use of emotional features alters the control flow and prompt content in a way that cannot be achieved by manual summarization alone. The result is an improved alignment between generated minutes and underlying meeting dynamics, which reduces the need for post-hoc edits and improves system precision.

The detailed architecture of the generative AI model and the speech recognition model allows the server to optimize processing parameters. For example, the server may select a reduced beam width for decoding audio segments that contain low complexity, or adjust a maximum token limit for generation when the meeting-record text is long. These decisions, executed in software modules on the server, directly affect computation time and memory footprint. Furthermore, the feedback loop using edited minutes as reference information enables adaptive optimization of prompt templates and decoding parameters, improving the accuracy of the generated output over time without manual programming effort.

In a variation, the server may integrate the speech recognition unit and the generative AI model into a single pipeline in which an intermediate representation, such as a sequence of word embeddings, is directly passed from the speech recognition front end to the generative back end. In another variation, the server may store audio and text data in a specialized database optimized for time-series data, thereby improving retrieval speed for specific time segments during meeting review. In yet another embodiment, the emotion recognition unit may use a multimodal model combining acoustic features and textual sentiment analysis, where text features are derived from the character information via a separate sentiment-classification neural network.

In all these embodiments, the server, rather than merely performing generic data acquisition, analysis, and display, implements specific data structures (time-aligned text records, emotion-tagged segments, versioned minutes documents) and specific algorithmic flows (incremental prompting, emotion-dependent prompt adjustment, reference-based prompt refinement) that improve computational efficiency and output quality. The causal relationship between these structures and flows and the technical effects is clear: segmented text and incremental prompting decrease computational load and latency; emotion-aware control yields more relevant and compact minutes, reducing user editing overhead; and the use of edited minutes as reference information guides future prompt design, which reduces repeated errors and contributes to long-term accuracy improvements.

Thus, the server, the terminal, and the described software modules cooperate as a concrete technical system that processes audio information, character information, emotional features, and generated text in a structured, non-conventional manner to improve the performance and reliability of meeting minutes generation as a computer-implemented technology.

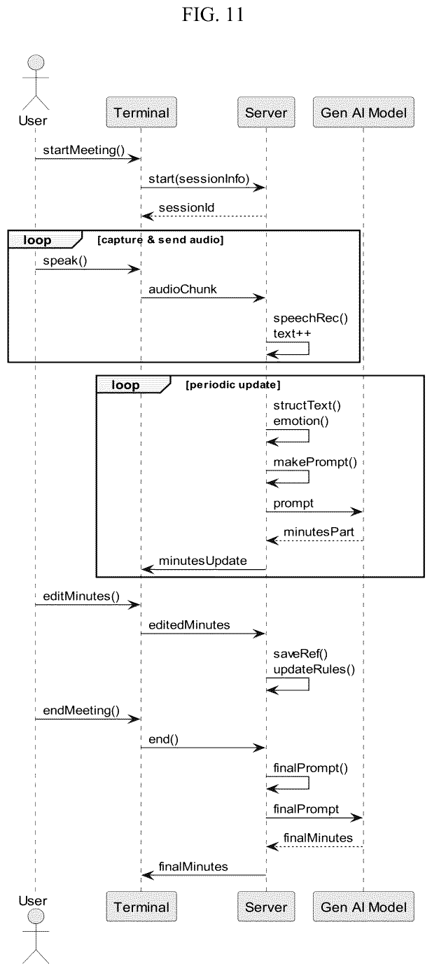

The following describes the processing flow using FIG. 11.

### Step 1

The user starts a meeting session on the terminal.

The user operates the terminal to launch a meeting application (for example, a web browser or native client) and selects an option such as “Start Meeting Recording.”

Input: user operation and meeting metadata (meeting title, expected language, participants).

Output: a meeting start request including meeting metadata.

The terminal bundles the meeting metadata into a request message and sends the request to the server via HTTPS or WebSocket.

The server receives the request, allocates a new session ID, creates a session record in a database, and returns the session ID to the terminal.

### Step 2

The terminal captures and digitizes audio from the user.

The user speaks during the meeting.

Input: analog sound waves from the user and other meeting participants.

Output: digital audio data frames (for example, 16-bit PCM, 16 kHz).

The terminal uses an audio driver and operating system audio APIs to sample the analog microphone signal, convert it into digital samples, and segment the samples into fixed-length frames (for example, 5-10 seconds).

The terminal attaches the session ID, timestamps, and audio format information to each frame and sends the audio frames to the server over the network.

### Step 3

The server receives and buffers audio information.

Input: digital audio frames with session ID and timestamps from the terminal.

Output: normalized audio buffer entries stored in memory or storage.

The server validates the session ID, writes the audio frames into a session-specific audio buffer, and may normalize the audio (for example, adjust volume, remove DC offset).

The server stores metadata such as frame index, start time, end time, and audio length in a data structure (for example, a table or list) associated with the meeting session.

### Step 4

The server performs speech recognition on the audio information.

Input: a digital audio frame from the audio buffer.

Output: recognized character information (text segments) with confidence scores.

The server passes the audio frame to a speech recognition unit, which extracts acoustic features (for example, MFCCs or log-mel filterbanks) and feeds feature sequences into an acoustic model (for example, a neural network-based acoustic model).

The server runs a decoding algorithm using an associated language model to compute the most probable word or subword sequence.

The server converts the decoded tokens into character information (for example, Unicode text), attaches language tags and confidence values, and stores each recognized segment with its time range in a transcript store.

### Step 5

The server manages and structures the recognized text as meeting-record text.

Input: character information segments with timestamps and optional speaker labels.

Output: structured meeting-record text organized by agenda or time segment.

The server's text management unit appends each new text segment to a time-ordered list and assigns it to a segment group, either by agenda item or by time window (for example, every 60 seconds).

The server may detect agenda transitions based on keywords in the character information (for example, “Move to the next agenda”) and update the current agenda identifier.

The server constructs meeting-record text blocks by concatenating text segments within each group and stores these blocks with identifiers (agenda ID or time segment ID) for later retrieval.

### Step 6

The server performs emotion recognition on the audio information.

Input: digital audio frames and corresponding time ranges from the audio buffer.

Output: emotional state labels or probabilities aligned with time ranges.

The server's emotion recognition unit computes prosodic and spectral features (for example, pitch, energy, spectral centroid, speaking rate) for sliding windows across the audio.

The server feeds feature vectors into a trained discrimination model (for example, a neural network or other classifier) which outputs probabilities for emotional categories such as neutral, positive, negative, or urgent.

The server assigns an emotional state to each time window based on the probabilities and maps the emotional state to the corresponding text segments by matching time ranges.

### Step 7

The server decides to update minutes and selects relevant meeting-record text.

Input: newly added meeting-record text blocks and corresponding emotional states.

Output: a selected portion of meeting-record text and associated emotional context for prompting.

The server checks whether a threshold is satisfied, such as a certain amount of new text or a time interval since the last update.

If the condition is met, the server retrieves the most recent meeting-record text blocks from the text management unit and the corresponding emotional state information from the emotion recognition unit.

The server limits the total length of text to stay within a token budget by truncating or summarizing older blocks when necessary.

### Step 8

The server generates a prompt sentence for the generative AI model.

Input: selected meeting-record text, emotional state information, and formatting requirements.

Output: a prompt sentence in natural language suitable for the generative AI model.

The server's prompt generation unit starts with a base instruction template (for example, “You are a generative AI model that creates structured meeting minutes.”).

The server inserts the selected meeting-record text into the template as transcript content and adds specific instructions (for example, “Output in Japanese. Include decisions and action items.”).

The server's prompt adjustment unit examines the emotional state and modifies the prompt sentence, for example by adding “Emphasize contentious points and propose detailed action items where participants show high urgency.”

The server assembles the complete prompt sentence, ensuring a clear separation between instructions and transcript content.

### Step 9

The server transmits the prompt sentence to the generative AI model and receives generated minutes text.

Input: the constructed prompt sentence and model configuration parameters (for example, model name, temperature, maximum tokens).

Output: generated minutes text corresponding to the latest meeting content.

The server's generation instruction unit encodes the prompt sentence as a request, sends it to the generative AI model via an API, and waits for a response.

The generative AI model processes the prompt sentence, and the server receives a sequence of generated tokens which it decodes into natural language text.

The server validates the received text (for example, checks for empty responses or truncation) and passes the generated text to the minutes management unit.

### Step 10

The server updates and stores the minutes document.

Input: previously stored minutes document and newly generated minutes text.

Output: an updated minutes document with a new version identifier.

The minutes management unit compares the new generated minutes text with the existing minutes document and decides whether to overwrite, append, or merge at the section level (for example, update only the current agenda section).

The server constructs an updated minutes document, assigns a version number and a timestamp, and stores it in a database or document store.

The server maintains links between the minutes sections and the underlying meeting-record text blocks for traceability.

### Step 11

The server sends the updated minutes document to the terminal.

Input: updated minutes document and session identifier.

Output: a minutes update message containing the latest minutes content.

The server formats the updated minutes document into a response structure (for example, a message including section titles, summaries, decisions, and action items) and transmits it to the terminal via the communication interface.

The terminal receives the message, parses the contents, and renders the updated minutes on the display device, optionally highlighting new or changed sections.

### Step 12

The user reviews and edits the minutes document on the terminal.

Input: displayed minutes document and user editing operations.

Output: an edited minutes document sent back to the server.

The user inspects the generated minutes on the terminal and may correct names, refine summaries, or add missing decisions and action items using text-editing controls.

The terminal captures the user's edits, constructs an edited minutes document, and transmits the edited document and associated metadata (for example, which sections were changed) to the server.

### Step 13

The server stores edited minutes as reference information for future processing.

Input: edited minutes document and associated original meeting-record text.

Output: reference information entry stored for later prompt optimization.

The server's minutes management unit saves the edited minutes document and records relationships between the edited text and the corresponding meeting-record text blocks and prior generated versions.

The server's prompt generation unit analyzes differences between generated and edited text, identifies recurring correction patterns (for example, consistent expansion of certain sections or preferred phrasing), and stores these patterns or rules as reference information.

### Step 14

The server uses reference information to adjust future prompt sentences and generation behavior.

Input: reference information derived from past edited minutes and current meeting-record text.

Output: adjusted prompt sentences and configuration parameters for subsequent calls to the generative AI model.

When constructing prompt sentences for new meetings or later segments, the server consults the stored reference information and modifies base templates, instruction wording, or emphasis rules accordingly (for example, “Always list action items with responsible person and due date if mentioned”).

The server may also adjust model parameters, such as reducing or increasing maximum token count for certain sections, based on observed editing behavior.

By feeding this information into future prompt sentences, the server gradually improves the accuracy and relevance of generated minutes, reducing the amount of manual editing required from the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional factory reporting systems rely heavily on manual input operations such as keypad entry or form-based interfaces on terminals and personal computers. These systems require workers to stop their physical tasks, operate user interfaces on limited-display devices, and manually structure work records into predefined formats. As a result, generation of accurate, structured work logs for progress management and quality management is time-consuming, error-prone, and highly dependent on the worker's familiarity with the interface. Further, in many existing systems, the server acts merely as a passive data store, and the burden of transforming unstructured observations into structured log data remains on the user side.

Even in systems that incorporate speech recognition, the recognized text is often stored as-is, without being transformed into normalized and structured records. Such systems typically do not provide an integrated mechanism for dynamically generating prompts for a generative AI model, orchestrating the conversion from raw speech to structured work records, and enriching those records with metadata useful for downstream management tasks. As a consequence, it is difficult to systematically query and analyze work data across production lines, operators, and time periods, which limits the effectiveness of progress monitoring and quality analysis.

Moreover, when large volumes of log data are accumulated over time, typical systems require separate analytic tools or human analysts to manually summarize and aggregate the data. These post-processing flows introduce latency, prevent real-time visibility into factory status, and do not leverage generative AI models in a coordinated manner. Existing approaches also fail to adapt log generation behavior to the worker's state or context inferred from the audio signal, thereby missing opportunities to automatically adjust the detail level or type of action item proposals based on such state information.

Accordingly, there is a need for an improved computer-implemented system that, at the server side, (i) orchestrates end-to-end processing from audio capture to structured log creation, (ii) programmatically constructs and adjusts prompt sentences to a generative AI model to generate standardized work logs, (iii) performs metadata enrichment and storage in a form optimized for progress and quality management, and (iv) uses the same generative AI infrastructure to automatically generate summaries and aggregated reports. There is also a need for a mechanism that improves the technical functioning of the server by integrating speech recognition, state estimation, and generative AI prompt control into a unified processing pipeline, thereby improving the efficiency, consistency, and timeliness of factory work logging and monitoring.

The specific processing by the specific processing unit 290 of the data processing device 12 in Application Example 1 is realized by the following means.

The present invention provides a server comprising a processor configured to acquire speech of a worker as audio data by using an audio input device, convert the audio data into text data by using a speech recognition function that performs acoustic processing and character string conversion processing, generate a prompt sentence for a generative AI model based on the text data and a recording format for work in a production facility, the prompt sentence instructing the generative AI model to automatically generate work record data, input the prompt sentence and the text data into the generative AI model to cause the generative AI model to generate structured work record data including date-time information, production line information, work content information, and result information, add user identification information, terminal identification information, processing time information, and equipment identification information to the work record data to convert the work record data into log data for progress management and quality management as recording data, store the log data in an information storage device, and, in response to an acquisition request from a management display device, acquire and output the log data, and further configured to generate a prompt sentence for the generative AI model with respect to a set of the log data stored in the information storage device, the prompt sentence instructing the generative AI model to automatically generate summary information and aggregation information, and cause the generative AI model to generate a summary report of work status and a summary report of quality trends and output the summary reports to the management display device, and further configured to perform an estimation process that extracts audio feature quantities from the audio data and estimates state information of the worker, adjust the prompt sentence to be input to the generative AI model based on the state information, and cause the generative AI model to generate work record data and action item proposal information reflecting the state information. This enables the server to technically improve the end-to-end processing of factory work reports by automatically transforming raw audio into structured, metadata-enriched log data optimized for progress and quality management, by dynamically controlling prompt sentences for the generative AI model to produce consistent records and real-time summary outputs, and by adapting log generation and action item proposals based on estimated worker state, thereby enhancing processing efficiency, data consistency, and real-time visibility within the computerized production management environment.

The term “audio input device” refers to a hardware component or combination of hardware and software configured to capture acoustic signals produced by a user and convert the acoustic signals into digital audio data that can be processed by a computing system.

The term “audio data” refers to digitized representations of sound signals obtained from an audio input device and formatted in a manner suitable for processing by a processor or software module.

The term “speech recognition function” refers to a software-implemented function that analyzes audio data using acoustic processing and language modeling to convert spoken utterances into corresponding text data.

The term “acoustic processing” refers to a series of signal processing operations performed on audio data, including at least one of feature extraction, noise reduction, and segmentation, to prepare the data for recognition of linguistic content.

The term “character string conversion processing” refers to a processing operation that transforms intermediate recognition results, such as phonetic units or tokens, into human-readable text sequences in a target language.

The term “text data” refers to digital data representing linguistic content in the form of character strings that are suitable for further natural language processing by software components.

The term “recording format for work in a production facility” refers to a predefined data structure or schema that specifies fields and layout for representing work-related information, including at least operation time, work location, work content, and work result.

The term “generative AI model” refers to a machine-learned computational model that receives text data as input and generates new text data as output, based on learned statistical relationships, for tasks including at least summarization, transformation, and structured text generation.

The term “prompt sentence” refers to a text instruction or set of text instructions provided as input to a generative AI model to specify a target task, output format, or behavioral constraint for the generative AI model.

The term “work record data” refers to data representing an individual work event in a production facility, including at least information related to when the work was performed, where it was performed, what operation was executed, and what outcome was obtained.

The term “structured work record data” refers to work record data organized according to a predefined schema such that the data includes explicitly separated fields for at least date-time information, production line information, work content information, and result information.

The term “date-time information” refers to data indicating a calendar date and a time of day associated with execution or logging of a work event.

The term “production line information” refers to data identifying a production line, workstation, or other production unit within a production facility to which a work event is associated.

The term “work content information” refers to data describing the type, purpose, or procedure of a work event carried out in a production facility.

The term “result information” refers to data indicating an outcome of a work event, including at least success, failure, presence of abnormalities, or other status.

The term “user identification information” refers to data that identifies an operator or worker who performed or reported a work event, such as a user identifier or account identifier.

The term “terminal identification information” refers to data that identifies a terminal device used for capturing or transmitting audio data or work information, such as a device identifier.

The term “processing time information” refers to data indicating a time at which a server or processor executed a processing step on work record data or log data.

The term “equipment identification information” refers to data that identifies equipment, machinery, or other physical assets involved in a work event in a production facility.

The term “log data” refers to data generated by combining structured work record data with associated metadata, including at least identification and time information, and stored for purposes of progress management, quality management, or audit.

The term “progress management” refers to a management activity or computational process that tracks and evaluates advancement of work against schedules, plans, or predefined milestones in a production environment.

The term “quality management” refers to a management activity or computational process that monitors, evaluates, and maintains quality levels of products or processes in a production environment, including detection of abnormalities and nonconformities.

The term “recording data” refers to data prepared and formatted for persistent storage in an information storage device to support subsequent retrieval, analysis, or display.

The term “information storage device” refers to a hardware and software system that persistently stores digital data, including at least non-volatile memory, magnetic storage, solid-state storage, or distributed storage resources.

The term “management display device” refers to a computing device, including at least a terminal, workstation, or display-equipped client, configured to present work-related information or log data to a manager or supervisor.

The term “acquisition request” refers to a request transmitted from a management display device or other client to a server to retrieve particular log data or reports based on specified conditions.

The term “summary information” refers to data that provides a condensed representation of a plurality of work records, emphasizing aggregated trends, key events, or overall status rather than details of individual records.

The term “aggregation information” refers to computed data derived from multiple log records using aggregation operations, including at least counting, summing, grouping, or averaging across specified dimensions such as time or production line.

The term “summary report of work status” refers to a report generated from log data and aggregation information that provides an overview of execution state, completion levels, or delays of work in a production environment.

The term “summary report of quality trends” refers to a report generated from log data and aggregation information that provides an overview of quality-related indicators, including at least defect occurrence, abnormality frequency, or process stability over time.

The term “audio feature quantities” refers to numerical or symbolic values computed from audio data that represent acoustic characteristics, including at least pitch, energy, spectral distribution, and temporal dynamics.

The term “state information of the worker” refers to inferred information about a worker's condition or context, including at least cognitive load, stress level, or attention level, estimated based on audio feature quantities or other indicators.

The term “estimation process” refers to a computational process that receives audio data or audio feature quantities as input and outputs state information of the worker using pattern recognition, machine learning, or statistical inference.

The term “action item proposal information” refers to data representing suggested follow-up tasks, corrections, or improvements that are derived from work record data, log data, or state information, and are intended to guide future actions in a production environment.

In one embodiment, a server cooperates with one or more terminals operated by users in a production facility to generate structured work records from spoken reports. The server includes at least one processor, a main memory, a non-volatile storage device, a network interface, and an information storage device implemented, for example, by a magnetic disk device, a solid state drive, or a managed cloud storage service. The terminal includes at least one processor, a microphone as an audio input device, a display, a memory, and a wireless or wired communication interface.

The terminal executes an application implemented, for example, as a native application on a portable information processing device such as a smartphone or tablet. The terminal uses an operating system-provided audio capture interface, such as an audio recording framework, to acquire the user's speech via the microphone. The terminal converts analog sound signals into digital audio data using an analog-to-digital converter and buffers pulse-code modulated samples in memory. The terminal optionally encodes the digital audio data into a compressed or uncompressed format, such as linear pulse-code modulation or a lossless audio coding format, and transmits the encoded audio data to the server over a communication path such as a wireless local area network or a mobile communication network by using a secure communication protocol.

The server receives the transmitted audio data through the network interface and stores the audio data in a buffer region of the memory. The server applies a speech recognition function to the audio data. In one example, the server invokes a remote speech recognition service provided by a cloud computing platform. In another example, the server executes a local automatic speech recognition engine implemented by a deep neural network performing acoustic modeling and a statistical or neural language model performing word sequence prediction. The server performs acoustic processing, including at least pre-emphasis filtering, framing, windowing, and feature extraction such as computation of Mel-frequency cepstral coefficients or filterbank energies. The server converts the extracted features into posterior probabilities over subword units by using a neural network model such as a deep feed-forward neural network, a convolutional neural network, or a recurrent neural network, and then decodes the posterior probabilities into text sequences by applying a decoding algorithm such as a beam search with a language model.

The server converts intermediate recognition results into character strings in a target language and generates text data representing the linguistic content of the worker's speech. The text data is stored as a string in a character encoding such as UTF-8 and is associated with metadata including a session identifier, a user identifier received from the terminal, and a terminal identifier stored in the server.

The server generates a prompt sentence for a generative AI model based on the text data and a predetermined recording format for work in a production facility. The server stores the recording format in a schema definition that specifies at least fields for date-time information, production line information, work content information, and result information. The server uses a prompt generation module implemented as program code executed by the processor to construct a prompt sentence that describes the target output structure and constraints to the generative AI model. The prompt generation module embeds the recording format, optional examples, and rules for parsing and normalization into the prompt sentence.

In one concrete example, the server generates the following prompt sentence: “Convert the following factory work report into a standardized log entry with the format: datetime, line number, task, result. Use the current system time if the time is not mentioned. Output only one line in CSV format.”

The server concatenates the prompt sentence and the recognized text to form an input text sequence to the generative AI model. For instance, when the user says “Line 1 maintenance completed, no abnormality,” the server provides to the generative AI model an input including the prompt sentence and the recognized text “Line 1 maintenance completed, no abnormality.”

The server deploys the generative AI model either as a locally hosted deep neural network or as an externally hosted inference service accessible via an application programming interface. In one embodiment, the generative AI model includes a transformer-based neural network having multiple self-attention layers, feed-forward layers, and layer normalization components. The server stores model parameters representing weights and biases for each layer. The server has previously trained the generative AI model on a corpus of domain-general and domain-specific text by using a training algorithm such as stochastic gradient descent or an adaptive gradient optimization method. The server minimizes a loss function such as cross-entropy between predicted token distributions and ground-truth tokens over sequences. During fine-tuning for production facility logs, the server supplies examples of input reports and desired structured outputs and updates model parameters by backpropagation, thereby biasing the model toward generating outputs aligned with the recording format.

The server invokes the generative AI model in inference mode with parameters such as model size, decoding temperature, and maximum output length. The generative AI model receives the joint input of the prompt sentence and the recognized text and computes hidden representations by iterative application of attention mechanisms over token embeddings. The model then outputs a sequence of tokens corresponding to a structured work record in the requested format. For the above example, the generative AI model generates an output string such as:
“2023-10-10 14:30, Line 1, Maintenance completed, No abnormality”

The server parses the output string by using a deterministic parser module to separate fields into structured work record data. The server maps each element of the output to internal data fields, for example, a timestamp field, a production line identifier field, a work description field, and a result field. The server additionally attaches user identification information, terminal identification information, processing time information obtained from a system clock, and equipment identification information received from configuration data or from the terminal. The server converts the combined data into log data by instantiating a data structure, such as an object or record, with explicit keys for each field. The server stores the log data into an information storage device, for example, by inserting rows into a relational database table with indexes over date-time and production line fields, or by writing documents into a document-oriented data store with appropriate indexing.

The server manages log data in a manner that improves data retrieval performance. For example, the server partitions log data by day or by production line to reduce search space for queries. The server creates compound indexes combining date-time and equipment identifiers to quickly locate relevant records. As a result, the server reduces disk input/output operations and network traffic when answering queries from management display devices, and thereby improves overall system responsiveness compared to naive storage of raw textual reports.

The management display device, which is one type of terminal, executes a user interface application that communicates with the server. The terminal sends an acquisition request including query parameters such as a time range or a production line identifier. The server receives the acquisition request, executes structured queries over the log data, and returns the corresponding records in a structured data format. The terminal renders the records on the display, for example, as a list view, a table view, or a graphical dashboard. The terminal allows the user to filter, sort, and inspect log details without performing any manual data structuring.

In addition to single-record generation, the server generates a prompt sentence for the generative AI model with respect to a set of log data stored in the information storage device. The server selects a subset of logs satisfying conditions such as a day or a shift. The server then constructs a prompt sentence that instructs the generative AI model to summarize and aggregate the selected logs. In one example, the server generates the following prompt sentence:

“Given the following list of factory work logs, summarize the overall work status and quality trends. Highlight the number of completed maintenance tasks per line, any occurrences of abnormalities, and any lines with repeated issues. Provide a concise textual summary.”

The server appends the selected logs to the prompt sentence and invokes the generative AI model. The generative AI model computes a condensed representation of the input sequence and produces a summary report of work status and a summary report of quality trends. The server sends the summary reports to the management display device, which displays them on a dashboard. The summary reports allow quick assessment of system state without requiring the server to perform custom statistical coding for each potential analysis. The generative AI model, guided by carefully designed prompt sentences and controlled decoding parameters, leverages its pre-trained internal representations to adaptively describe patterns in the logs.

In one embodiment, the server further performs an estimation process to infer state information of the worker from audio feature quantities. The server extracts prosodic and spectral features from the audio data, such as pitch, energy, speaking rate, formant distribution, and pause statistics. The server normalizes these features and inputs them to a classifier model, such as a feed-forward neural network or a recurrent neural network, that has been trained to map feature sequences to state labels representing, for example, stress, fatigue, or high workload. The server trains the classifier by using supervised learning, where labeled audio segments are associated with known states, and minimizes a loss function such as categorical cross-entropy by adjusting model weights through backpropagation with gradient descent. The server optionally applies data augmentation techniques to improve robustness, such as adding noise, altering speed, or shifting pitch in training data.

The server adjusts the prompt sentence supplied to the generative AI model based on the estimated state information. For instance, if the worker is estimated to be in a high-stress state, the server modifies the prompt sentence to include instructions to generate more explicit and detailed action item proposals and to flag potential safety-related follow-ups. If the worker is estimated to be in a normal state, the server generates a more concise prompt sentence focusing on essential log fields. Because the server programmatically modifies the prompt sentence according to algorithmically determined state conditions, the system dynamically adapts log generation without requiring the user to specify additional options.

The generative AI model then generates work record data and action item proposal information that reflect the adjusted prompt sentence, and the server stores the proposed actions along with the log data.

This configuration provides a technical improvement over conventional systems in several respects. The server reduces processing latency and resource consumption by (i) converting unstructured audio streams directly into normalized log data without manual intermediate editing, (ii) structuring records according to a machine-optimized schema that supports efficient indexing and querying, and (iii) using a generative AI model to perform flexible, schema-aware text transformation in a single inference pass instead of multiple rule-based or scripting steps. The consistent prompt sentence and parsing rules ensure that output logs adhere to a machine-friendly format, which improves downstream processing accuracy and reduces parsing errors.

The server also reduces communication and storage overhead by eliminating the need to transmit or store entire raw conversation transcripts. Instead, the server stores compact structured data and summary reports, resulting in smaller record sizes and faster transmission to management display devices. The generative AI model, when driven by specific prompt sentences designed for this system, applies a non-conventional processing flow that differs from human summarization: the model operates on token-level representations using attention-based weighting, integrates long-range dependencies, and produces normalized outputs even when inputs are inconsistent or partially incomplete. This behavior yields more consistent and machine-actionable records than naïve human or template-based input.

In further embodiments, the server implements different variations of the generative AI model. In a first variation, the server uses a large transformer model with hundreds of millions of parameters hosted on a dedicated accelerator device such as a graphics processing unit. In a second variation, the server uses a smaller distilled model with reduced layer depth and width for on-premises deployment, trading off some expressiveness for lower inference latency and power consumption. In a third variation, the server ensembles outputs from multiple generative AI models with different architectures or training data biases, and selects or merges outputs based on confidence metrics or rule-based checks.

The terminal may also vary in configuration. In one embodiment, the terminal performs on-device speech recognition using a lightweight neural engine and sends text instead of audio to the server, thereby reducing network bandwidth usage and latency. In another embodiment, the terminal performs pre-processing, such as noise suppression or speaker diarization, to improve recognition accuracy on the server side. In yet another embodiment, the terminal caches logs locally in case of network disconnection and resends them when communication is restored.

Because the server is responsible for orchestrating interactions among the speech recognition function, the generative AI model, the state estimation model, and the storage subsystem, the system as a whole improves computer technology. The server executes specific algorithms to generate, adjust, and apply prompt sentences, to parse generative outputs into structured data, and to control data storage structures for efficient retrieval. These operations result in measurable improvements in processing speed, error rate, and resource utilization relative to systems that simply digitize and archive human reports without integrated neural processing and prompt-driven structuring. The server thereby transforms raw sensor signals from a physical environment into optimized computational representations that directly support automated technical management tasks in a production facility.

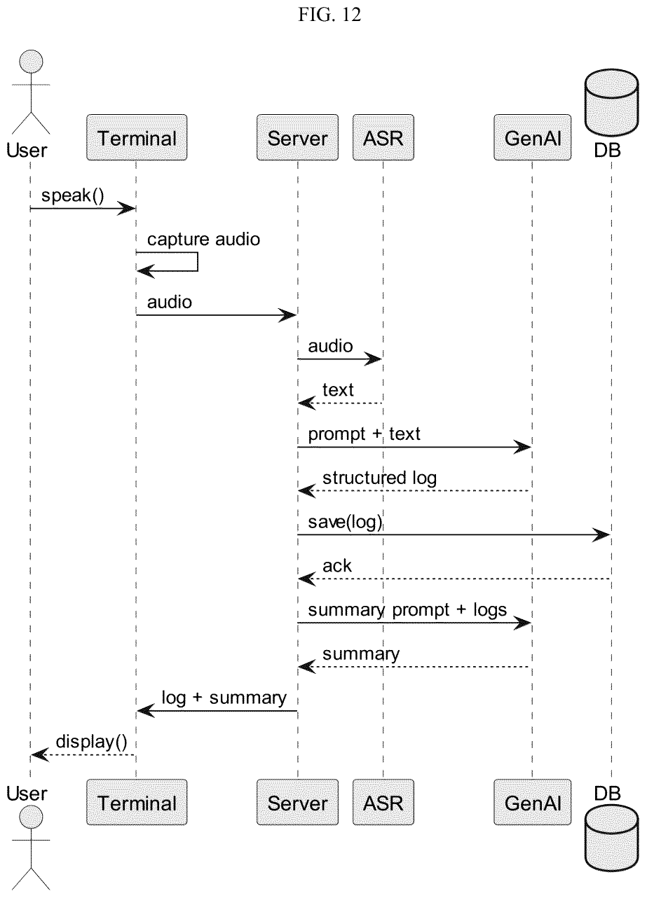

The following describes the processing flow using FIG. 12.

### Step 1

The user utters a work report near the terminal's microphone, for example, “Line 1 maintenance completed, no abnormality.” The input in this step is an analog acoustic signal produced by the user's speech, and the output is an acoustic waveform received at the microphone.

### Step 2

The terminal converts the analog acoustic signal into digital audio data using an analog-to-digital converter and an operating system audio API. The input is the analog waveform from the microphone, and the output is a sequence of sampled audio frames (for example, 16 kHz PCM samples) stored in a buffer. The terminal performs sampling, quantization, and buffering operations to form continuous digital audio data.

### Step 3

The terminal packages the digital audio data into a transmission unit, optionally encodes it (for example, into a linear PCM or lossless format), and sends it to the server via a secure communication protocol over a network. The input is the buffered digital audio data, and the output is a network message containing the audio payload, headers, and authentication information. The terminal performs data framing, encryption, and network socket transmission.

### Step 4

The server receives the network message through a network interface and extracts the audio payload for further processing. The input is the network packet stream containing audio data and metadata, and the output is raw audio data stored in a memory buffer and associated session information. The server performs packet reassembly, header parsing, integrity checking, and buffering of the audio stream.

### Step 5

The server performs acoustic pre-processing on the audio data, including pre-emphasis, framing, windowing, and feature extraction such as Mel-frequency cepstral coefficients or filterbank features. The input is the buffered raw audio waveform, and the output is a sequence of feature vectors representing each time frame. The server applies digital signal processing operations to transform time-domain samples into compact feature representations suitable for speech recognition.

### Step 6

The server applies a speech recognition function using an acoustic model and a language model to convert the feature vectors into text data. The input is the sequence of feature vectors, and the output is a recognized text string representing the user's spoken work report. The server executes a neural network to compute posterior probabilities over subword units and runs a decoding algorithm such as beam search with a language model to obtain the most likely text sequence.

### Step 7

The server normalizes the recognized text by removing extraneous symbols, standardizing number formats, and trimming leading and trailing whitespace, and then stores it as text data associated with a session identifier. The input is the raw recognized text string, and the output is normalized text data ready for further natural language processing. The server performs string manipulation, tokenization, and mapping operations.

### Step 8

The server determines a recording format schema for work logs, including fields such as datetime, line number, task, and result, and prepares a prompt sentence instructing a generative AI model to generate structured work record data. The input is the normalized text data and the predefined recording schema, and the output is a prompt sentence text specifying required output format and rules. The server performs template filling, rule selection, and text concatenation to compose the prompt sentence.

### Step 9

The server combines the prompt sentence and the recognized text into a single input sequence for the generative AI model. The input is the prompt sentence and the normalized text data, and the output is a composite instruction text that includes both the task description and the content to be transformed. The server concatenates strings, inserts line breaks or delimiters, and encodes the combined text into tokens for the model.

### Step 10

The server sends the tokenized composite instruction to the generative AI model and executes an inference process to obtain a structured work record. The input is the token sequence representing the prompt sentence and recognized text, and the output is a token sequence representing a structured log in the specified format. The generative AI model internally applies multiple transformer layers, attention mechanisms, and feed-forward operations to compute hidden representations and then decodes them into output tokens according to decoding parameters such as temperature and maximum length.

### Step 11

The server decodes the output token sequence from the generative AI model into a human-readable string and parses it into individual fields of structured work record data. The input is the generated output string (for example, “2023-10-10 14:30, Line 1, Maintenance completed, No abnormality”), and the output is a structured record object with separate entries for datetime, line identifier, task description, and result. The server performs character decoding, delimiter-based splitting, type conversion, and validation checks on each field.

### Step 12

The server enriches the structured work record data by adding metadata such as user identification information, terminal identification information, processing time information from a system clock, and equipment identification information retrieved from configuration data. The input is the parsed work record object and associated session metadata, and the output is complete log data including all required fields for progress and quality management. The server merges data structures and assigns values to designated metadata keys.

### Step 13

The server stores the log data into an information storage device, such as a relational database or document store, by executing a write operation with appropriate indexing. The input is the fully populated log data record, and the output is a persistent database entry identified by a unique key. The server performs database connection, insert or update operations, and index maintenance, thereby enabling efficient future retrieval.

### Step 14

The server receives an acquisition request from a management terminal that specifies query conditions such as time intervals, production lines, or result statuses. The input is a request message containing query parameters, and the output is a query plan prepared for execution against the stored log data. The server parses the request, validates parameters, and constructs structured query expressions.

### Step 15

The server executes the query against the information storage device to retrieve matching log records. The input is the query plan and database contents, and the output is a collection of log data records satisfying the conditions. The server uses indexes to limit the search space, performs filtering, and sorts results according to requested ordering to reduce computation time and I/O operations.

### Step 16

The server generates a prompt sentence for the generative AI model to create a summary report of work status and quality trends based on a set of retrieved logs. The input is the collection of log data records and a summarization template, and the output is a summarization prompt sentence specifying required statistics and narrative form. The server analyzes the number and type of records and inserts instructions into the prompt to guide aggregation and emphasis.

### Step 17

The server concatenates the summarization prompt sentence with a textual representation of the selected log records and sends this combined text to the generative AI model for inference. The input is the prompt and the encoded logs, and the output is an output sequence representing a summary report. The generative AI model processes the input with its attention-based architecture, identifies patterns such as repeated errors, and produces a concise textual description of overall status and trends.

### Step 18

The server passes the summary report and, optionally, the underlying structured records to the management terminal, which displays them on a dashboard. The input is the summary text and structured data objects, and the output is a visual representation on the terminal's display. The terminal renders tables, charts, and text views based on the received data to allow rapid comprehension by the user.

### Step 19

The server optionally performs state estimation of the worker by extracting audio feature quantities from the original audio data and inputting them into a trained classifier model. The input is the raw or pre-processed audio data, and the output is state information labels such as stress level or fatigue level. The server calculates features like pitch contours and energy statistics, feeds them into a neural classifier, and obtains probability distributions over state categories.

### Step 20

The server modifies subsequent prompt sentences for the generative AI model according to the estimated state information to adjust the level of detail and type of action item proposals included in generated outputs. The input is the current state information and a base prompt template, and the output is an adapted prompt sentence that reflects state-dependent requirements (for example, requesting more explicit safety checks for high-stress conditions). The server applies rule-based logic to insert or remove instructions in the prompt before invoking the generative AI model in further processing cycles.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented meeting support systems typically perform speech recognition on continuous audio streams and then generate a static text record of the meeting. However, such systems suffer from several technical limitations at the level of computer processing and resource management.

First, when long audio streams and large volumes of recognized text are processed as monolithic data objects, memory usage and processing time on general-purpose computing hardware increase significantly. This leads to higher latency in generating usable minutes and reduces system responsiveness for real-time or near-real-time applications. Existing systems generally lack mechanisms for time-based segmentation of audio data and corresponding structuring of text data that are optimized for downstream processing by generative AI models having limited input capacities.

Second, conventional systems do not adapt their prompt construction or summary granularity to the actual characteristics of the recognized text, such as length, topic shifts, or distribution of important terms. Static or manually designed prompts for generative AI models often result in suboptimal use of model input quotas, unnecessary token consumption, and inconsistent sectioning and highlighting in the generated minutes. This degrades the efficiency and predictability of generative processing on computing resources.

Third, in typical workflows, user edits to automatically generated minutes are not effectively reintegrated into the AI processing pipeline. Many systems simply treat the user's edits as a final, local post-processing step. As a result, the computer system does not exploit user edits to refine subsequent AI generations, to improve the structure or clarity of the minutes, or to reduce future correction effort. This limits the technical advantage of iterative human-AI collaboration and prevents the system from leveraging edited content as improved input for further automated processing.

Fourth, there is often no integrated mechanism to transform raw AI outputs into a structured, machine-managed document representation that supports automatic section separation, heading assignment, and emphasis of specific categories of information, such as deadlines or responsible persons. Consequently, additional manual formatting is required on client devices, increasing network traffic (due to repeated download and upload of partially formatted documents) and inefficient use of processing capabilities distributed between servers and terminals.

Accordingly, there is a need for an improved computer-implemented system that: (i) segments and structures audio and text data in a manner tuned to the constraints of generative AI models; (ii) automatically constructs and dynamically adjusts prompt sentences based on characteristics of the recognized text; (iii) manages an iterative workflow in which user-edited minutes are reinjected into the generative AI pipeline through regeneration prompts; and (iv) performs server-side document formatting, including standardized section structuring and emphasis of key informational elements, so as to improve processing efficiency, reduce latency, and enhance the technical functioning of the overall meeting minutes generation system.

The specific processing by the specific processing unit 290 of the data processing device 12 in Example 2 is realized by the following means.

The present invention provides a server comprising a processor configured to segment incoming audio information into time-based units with associated identification information, convert the segmented audio information into structured character information using a speech recognition processing function, perform normalization and splitting of the character information according to an input capacity of a generative AI model, automatically generate and dynamically adjust prompt sentences based on characteristics of the character information and meeting context, supply the prompt sentences together with the character information to the generative AI model so as to obtain minutes separated into predetermined sections, convert the obtained minutes into a standardized document format with server-side application of headings and emphasis to key informational elements, transmit the formatted minutes to a terminal device for editable display, and receive and reintegrate editing results from the terminal device, including regenerating refined minutes by providing regeneration prompt sentences and edited minutes back to the generative AI model. This enables improved utilization of computing resources and memory by processing audio and text data in segmented and structured forms, optimized interaction with generative AI models through context-aware prompt construction, reduced end-to-end latency and network overhead by centralizing document structuring and emphasis on the server side, and technically enhanced iterative refinement of meeting minutes by incorporating user edits into subsequent AI processing, thereby improving the overall efficiency, reliability, and quality of computer-implemented meeting minutes generation.

The term “audio acquisition device” refers to any hardware component or combination of hardware components configured to capture analog sound signals corresponding to speech of meeting participants and convert the sound signals into digital audio information suitable for processing by a computing apparatus.

The term “audio information” refers to digital data representing sound signals obtained from one or more audio acquisition devices, the digital data being encoded in a format processable by a speech recognition processing function.

The term “time-based segments” refers to portions of audio information or character information that are divided according to elapsed time intervals, each portion corresponding to a predetermined time length in a continuous stream.

The term “identification information” refers to metadata associated with a time-based segment, the metadata including at least one of a meeting identifier, a segment identifier, a timestamp, a channel identifier, or other information enabling discrimination and management of segments.

The term “speech recognition processing function” refers to any software, firmware, or hardware-implemented functionality configured to convert audio information into character information using at least an acoustic model and a language model.

The term “acoustic model” refers to a data structure and associated algorithms trained to map acoustic features extracted from audio information to probabilistic representations of phonetic or sub-word units.

The term “language model” refers to a data structure and associated algorithms trained to estimate probabilities of sequences of words or tokens for one or more languages, and to output likely word or token sequences based on such probabilities.

The term “character information” refers to digital textual data obtained by processing audio information with a speech recognition processing function, the digital textual data representing recognized words, symbols, or tokens.

The term “utterance” refers to a unit of character information corresponding to a continuous segment of speech by a speaker, defined by temporal boundaries or recognized linguistic boundaries.

The term “structure and store the character information on a unit basis of utterances” refers to organizing character information into discrete data objects each corresponding to an utterance and storing the data objects together with associated metadata for later processing.

The term “normalization process” refers to a process performed on character information to standardize or clean the text, the process including at least one of removing filler expressions, correcting spacing, unifying punctuation, or performing other textual refinements.

The term “splitting process” refers to a process that divides character information into multiple parts such that each part satisfies a predefined size condition, including a condition corresponding to an input capacity of a generative AI model.

The term “generative AI model” refers to a machine-learned model configured to generate textual output in response to textual input, the model being trained on large-scale data and capable of performing natural language understanding and generation.

The term “meeting type” refers to classification information indicating a category or purpose of a meeting, such as a planning meeting, status meeting, review meeting, or other type, used to influence generation of prompt sentences or minutes.

The term “prompt template” refers to a predefined textual pattern or structure including fixed phrases and variable fields, the pattern being used as a basis for constructing a prompt sentence for a generative AI model.

The term “prompt sentence” refers to textual instructions, optionally including embedded character information or references thereto, provided as input to a generative AI model to specify a desired content, style, or structure of generated minutes.

The term “output format of the minutes” refers to a specification of structural and stylistic attributes of meeting minutes, including at least one of headings, section order, bullet lists, and emphasis styles.

The term “important items” refers to content elements identified as significant within the context of a meeting, including at least one of key decisions, main conclusions, or critical information to be retained.

The term “summary of discussion” refers to condensed textual content that captures essential points and progression of conversation from the meeting without reproducing the full transcript.

The term “action items” refers to tasks or follow-up activities derived from the meeting, each task being associated with at least a description of the activity and optionally including responsible participants and deadlines.

The term “standardized document format” refers to a predefined representation of minutes in a document structure suitable for consistent rendering, storage, and transmission, including but not limited to markup-based formats and page-description formats.

The term “document generation processing function” refers to software, firmware, or hardware-implemented functionality configured to convert structured minutes into a standardized document format and to apply layout and formatting rules.

The term “headings” refers to textual labels or titles applied to sections of a document for indicating a category or topic of the corresponding section.

The term “important terms” refers to words or phrases in the minutes that convey critical semantic information, including at least topic keywords, decision phrases, or domain-specific terms.

The term “deadline information” refers to data in the minutes that specify temporal constraints or due dates associated with action items or decisions.

The term “person-in-charge information” refers to data in the minutes identifying at least one individual or role responsible for an action item or decision.

The term “terminal device” refers to any computing device, including but not limited to a personal computer, a tablet device, or a mobile communication device, configured to communicate with the server and to display and edit minutes.

The term “editable display format” refers to a presentation of minutes on a terminal device in which a user can modify, insert, or delete textual content through user interface operations.

The term “editing results” refers to modified minutes or additional instructions generated by a user on a terminal device and transmitted to the server, the modified minutes or instructions reflecting changes to automatically generated minutes.

The term “regeneration prompt sentence” refers to a prompt sentence constructed based on edited minutes and optional additional instructions, the prompt sentence instructing a generative AI model to reconstruct, refine, or reformat the edited minutes.

The term “refined minutes” refers to minutes generated by a generative AI model in response to a regeneration prompt sentence, the minutes having improved clarity, organization, or consistency compared with previously generated or edited minutes.

The term “output granularity” refers to a degree of detail in generated minutes, including at least a level of segmentation of topics and a density of information per section or per bullet item.

The term “summarization level” refers to an extent to which content is condensed or abstracted in generated minutes, ranging from highly condensed summaries to detailed near-transcript representations.

The term “section structure” refers to a configuration of sections in the minutes, including the number, names, and ordering of sections such as important items, summary of discussion, and action items.

The term “occurrence status of important terms” refers to information characterizing frequency, position, or distribution of important terms within character information.

The term “meeting minutes” refers to a structured textual record of a meeting generated or refined by the system, the record including at least important items, a summary of discussion, and action items.

In one embodiment, a server cooperates with one or more terminals operated by a user to implement the claimed system. The server includes at least one central processing unit (CPU), a main memory, a non-volatile storage device such as a solid-state drive, a network interface, and an audio interface. The server executes an operating system such as a general-purpose server operating system and application software modules that implement audio acquisition, speech recognition, text processing, prompt sentence generation, interaction with a generative AI model, document generation, and communication with the terminals.

The server uses an audio acquisition device connected through the audio interface to capture speech of meeting participants. The audio acquisition device may include one or more microphones connected via a digital audio interface. The server controls drivers such as an audio subsystem to sample the analog sound signals at a predetermined sampling rate (for example, 16 kHz, 16-bit linear PCM) and stores the resulting digital audio information in the main memory and the non-volatile storage device. The server segments the continuous audio information into time-based units, for example segments of several seconds, and associates each segment with identification information. The identification information may include, for example, a meeting identifier, a segment index, a start timestamp, and a channel identifier corresponding to a particular microphone. This segmentation and tagging enable the server to process the audio information in smaller units, which reduces peak memory usage and allows parallel processing on multi-core hardware.

The server uses a speech recognition processing module to convert the audio information into character information. The server first extracts acoustic features (for example, Mel-frequency cepstral coefficients, log-Mel filter bank features, or spectrogram patches) from each time-based segment. The server then inputs these acoustic features to an acoustic model and a language model. In one embodiment, the acoustic model is implemented as a deep neural network such as a convolutional neural network or a recurrent neural network trained to output probability distributions over phonetic units. The language model is implemented as an n-gram model or a neural sequence model trained to output probability distributions over word or subword sequences. The server executes a decoding algorithm such as beam search to infer the most probable sequence of tokens given the acoustic model outputs and the language model probabilities. The server thereby generates character information corresponding to the speech content. The server structures the character information on a unit basis of utterances by grouping tokens between silence intervals or segment boundaries into utterance objects. Each utterance object includes fields such as text content, start time, end time, and an optional speaker label. The server stores these utterance objects in a data store as structured records.

The server performs a normalization process on the stored character information. The server executes text normalization algorithms that remove filler phrases such as “um” or “uh” when appropriate, unify punctuation, normalize spacing, and optionally correct simple recognition errors using dictionary-based replacement rules. The server also removes or compresses repetitive phrases when they are detected by analyzing n-gram frequencies. This normalization process reduces noise in the character information and reduces the number of tokens to be processed by the generative AI model, thereby improving calculation efficiency and reducing latency.

The server performs a splitting process on the character information when the total size of the text exceeds a predetermined limit related to the input capacity of the generative AI model.

The server measures the length of the character information in terms of tokens or characters using a tokenizer compatible with the generative AI model. When the measured length exceeds a threshold, the server splits the character information into segments such that each segment falls within the input limit while preserving utterance boundaries. The server records segment indices and maintains a mapping between the original utterance order and the segment order. This splitting process allows the server to apply the generative AI model to very long meetings without exceeding model constraints, and it allows the server to process multiple segments in a pipeline or in parallel, thereby improving throughput.

The server analyzes the character information to determine meeting characteristics such as meeting type, topic changes, and occurrence status of important terms. The server may determine the meeting type based on metadata specified by the user or inferred from keywords detected in the character information. The server detects topic changes by computing semantic similarity between consecutive utterances using vector representations such as embeddings generated by a neural encoder, and by detecting points where the similarity falls below a threshold. The server identifies important terms by computing term-frequency statistics, by using part-of-speech tagging and named entity recognition, or by referencing a domain-specific dictionary. The server stores such analysis results as additional metadata accompanying each utterance or segment.

Based on the analysis results, the server generates a prompt sentence to be provided to the generative AI model. The server stores multiple prompt templates in the storage device. Each prompt template is a text pattern including fixed instructions and placeholders for insertion of transcript segments and context information. In one example, the server uses a prompt template such as:
“You are a tool for generating meeting minutes. Read the following meeting transcript and generate structured minutes. Include three sections: (1) Important Points, (2) Summary of Discussion, and (3) Action Items. Use clear bullet points.”

The server replaces placeholders in the template with the actual character information or segment text, meeting type, and instructions regarding output granularity and summarization level. For example, the server appends to the above template:
“Focus on project planning topics and highlight all dates and responsible persons. Transcript: [TRANSCRIPT_TEXT].”

The server dynamically adjusts the content of the prompt sentence in accordance with the length of the character information, the detected topic changes, and the occurrence status of important terms. For a very long meeting, the server adds instructions to produce a higher level of summarization. For a meeting with frequent topic changes, the server adds instructions to group content by topic. For a meeting with many important dates and deadlines, the server adds instructions to explicitly list all deadlines under the action items section. By adjusting the prompt sentence in this way, the server improves the efficiency of the generative AI model by guiding it to allocate model capacity to the most relevant content and by reducing unnecessary verbosity.

The server uses a generative AI model to generate minutes based on the prompt sentence and the character information. In one embodiment, the generative AI model is implemented as a transformer-based neural network trained on large-scale text data. The model architecture may include multiple layers of self-attention and feed-forward sublayers. The server configures parameters such as temperature, maximum output length, and decoding strategy (for example, greedy decoding or sampling with nucleus sampling) to control the variability and length of the model output. The server provides as input a sequence consisting of the prompt sentence and the character information. The generative AI model processes the sequence by computing attention weights across tokens, generating contextualized representations, and sequentially generating output tokens based on learned probability distributions. The server interprets the generated tokens as the minutes text.

The server post-processes the generated minutes to separate sections corresponding to important items, summary of discussion, and action items. The server analyzes the generated text to detect headings such as “Important Points:”, “Summary of Discussion:”, and “Action Items:”, and splits the text accordingly. The server stores each section in a structured data format, such as a list of bullet items for each section. The server then applies a document generation processing function to convert the structured minutes into a standardized document format such as markup-based content. The server assigns headings to each section using heading tags, converts bullet items into list structures, and applies style attributes to emphasize important terms, deadline information, and person-in-charge information. The server may detect dates by using pattern matching on numeric expressions and calendar terms, detect responsible persons by analyzing entity labels, and wrap these items with emphasis tags. This server-side formatting reduces processing requirements on the terminals and ensures consistent structure across different devices.

The server transmits the formatted minutes to a terminal over a communication network using a protocol such as HTTP over a secure connection. The server sends the minutes in a form that can be rendered in an editable display format at the terminal. The terminal is, for example, a personal computer, a tablet device, or a mobile communication device. The terminal executes a client application or a web browser that renders the minutes as an interactive document, for example with text fields and editable list items. The terminal allows a user to modify the text, insert additional items, or delete erroneous items through user interface operations such as keyboard input and pointing device actions.

The user operates the terminal to review the minutes, confirm the accuracy of the generated content, and make corrections where necessary. For example, the user may change a sentence “The new product is scheduled to be launched next month.” to “The new product is scheduled to be launched on April 15.” The user may also add an action item such as “Prepare detailed marketing budget before April 5 (Owner: Marketing Manager).” The terminal records these modifications as editing results, which may include the edited minutes content and additional instructions from the user, such as a request to improve clarity or to adjust the level of detail.

The terminal transmits the editing results to the server. The server receives the editing results and updates the stored minutes accordingly. The server may maintain version information so that both the original AI-generated minutes and the user-edited minutes are accessible. In addition, the server may generate a regeneration prompt sentence based on the edited minutes and any additional instructions contained in the editing results. For example, the server may construct a regeneration prompt sentence such as:
“Refine the following meeting minutes. Keep all factual content, but improve clarity and organization. Maintain the sections Important Points, Summary of Discussion, and Action Items. Minutes: [EDITED_MINUTES_TEXT].”

The server provides the regeneration prompt sentence and the edited minutes to the generative AI model, which generates refined minutes. The server then returns the refined minutes to the terminal for display. This iterative regeneration process allows the system to incorporate user corrections into subsequent automatic processing and to further improve clarity and consistency of the minutes without requiring the user to perform all formatting and restructuring manually.

The server improves computer technology in several ways. By segmenting audio information into time-based units and structuring character information on a unit basis of utterances, the server minimizes memory fragmentation and facilitates parallel processing on multi-core CPUs or distributed servers. This segmentation reduces the peak memory footprint and allows more efficient use of caches, thereby improving processing speed. The normalization and splitting processes reduce the number of tokens to be processed and ensure that the generative AI model receives inputs within its optimized capacity, which reduces computational overhead and shortens response times.

The server's dynamic generation and adjustment of prompt sentences based on measured characteristics of the character information constitute a non-conventional control scheme for the generative AI model. Instead of statically configuring prompts, the server automatically adjusts output granularity, summarization level, and section structure. This results in a more efficient allocation of computational resources within the generative AI model, because the model processes only the level of detail necessary for the current meeting context. This adaptation reduces unnecessary token generation, which in turn reduces processing time and energy consumption on the hardware executing the model.

The server's centralized document generation processing reduces communication load between the server and the terminals. Because the server generates a standardized document format with headings and emphasis, the terminals do not need to download raw text multiple times and then upload fully formatted versions. Instead, the terminals exchange compact structured data and editing results, which decreases network traffic and reduces latency for users on bandwidth-limited connections.

The server can employ different configurations of generative AI models and learning methods. In one variant, the server hosts a trained transformer model locally and uses hardware accelerators such as graphics processing units to execute the model. In another variant, the server communicates with a remote AI service but still performs all segmentation, normalization, prompt generation, and post-processing described above. In either case, the server may train or fine-tune the generative AI model using meeting transcripts and minutes as training data. The server uses a learning algorithm such as stochastic gradient descent or an adaptive optimization method to minimize a loss function such as cross-entropy between predicted tokens and reference tokens. During training, the server updates model weights based on gradients computed by backpropagation. The server may perform data augmentation by randomly masking tokens, shuffling non-critical sentence order within a section, or injecting synthetic noise into transcripts, to improve robustness. These training procedures improve the accuracy and stability of the generative AI model when generating minutes from noisy or incomplete input.

The server's control over the generative AI model and the specific data structures used for utterances, segments, and minutes distinguish this system from mere automation of human minute-taking. Human note-taking does not naturally exploit segmentation according to AI model capacities, dynamic prompt construction based on token-level measurements, or formalized data structures with explicit mapping from utterances to summarized sections. By implementing these machine-oriented structures and algorithms, the server achieves technical effects such as reduced computational complexity, improved summarization accuracy, and more predictable latency. The causal relationship between these structures and the technical effects can be summarized as follows: segmentation and normalization reduce input size and noise, which improves model inference speed and accuracy; dynamic prompt control allocates model capacity to relevant content, which improves the quality of generated minutes under fixed computational budgets; and server-side document structuring reduces redundant client-side processing and network usage, which improves the overall responsiveness of the distributed system.

In another embodiment, the server may employ different types of acoustic models, such as a transformer-based end-to-end recognizer, or may use different neural architectures for the generative AI model, such as an encoder-decoder model with attention. The server may also choose different strategies for detecting topic changes or important terms, such as clustering utterance embeddings or using rule-based keyword patterns. The terminal may be implemented as a dedicated application or as a browser-based interface. The user may interact with the system using additional input methods, such as voice commands to request regeneration or to mark certain utterances as particularly important. All such variations are encompassed within the scope of the embodiments, as long as the server maintains the essential functions of segmenting audio and text, generating and adjusting prompt sentences, interacting with a generative AI model to obtain structured minutes, performing server-side document formatting, and reintegrating user editing results to refine the minutes.

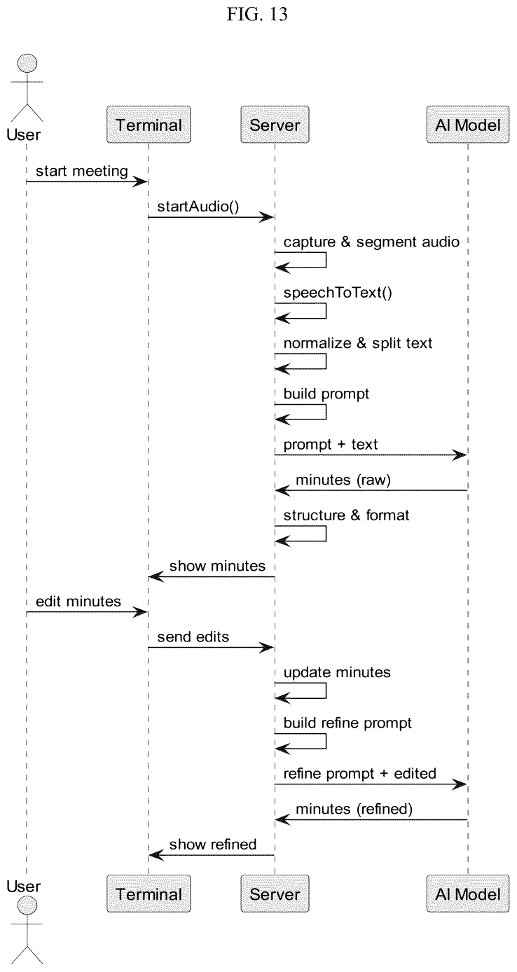

The following describes the processing flow using FIG. 13.

### Step 1

The server acquires audio information from a meeting.

The server receives as input analog speech signals from an audio acquisition device including one or more microphones. The server uses an audio driver to sample the analog signals at a fixed sampling rate and bit depth and converts them into digital audio information in a linear PCM format. The server then divides the continuous digital audio stream into time-based segments, for example segments of 5 to 10 seconds, and assigns identification information such as a meeting identifier, a segment index, and a timestamp to each segment. The server outputs segmented audio data objects, each containing the audio samples and the associated identification information.

### Step 2

The server stores and manages the segmented audio information.

The server receives as input the segmented audio data objects from Step 1. The server writes each audio segment into a storage device, such as a solid-state drive, and registers metadata for each segment in a data structure, for example a segment table keyed by meeting identifier and segment index. The server performs data organization operations to enable efficient retrieval based on time intervals and meeting identifiers. The server outputs a set of stored segment records that can be accessed by later processing modules.

### Step 3

The server performs feature extraction from the audio segments.

The server receives as input the stored segment records from Step 2. For each segment, the server computes acoustic features such as Mel-frequency cepstral coefficients or log-Mel filter bank energies by applying a short-time Fourier transform, windowing, and filter bank operations to the audio samples. The server normalizes the features, for example by mean-variance normalization, to reduce variability due to recording conditions. The server outputs feature matrices for each audio segment, where each matrix contains time frames and corresponding feature vectors, along with the original segment identification information.

### Step 4

The server executes speech recognition to generate character information.

The server receives as input the feature matrices from Step 3. The server inputs each feature matrix to an acoustic model and a language model implemented as a speech recognition processing function. The server runs a decoding algorithm, such as beam search, to compute the most probable sequence of tokens for each segment based on the acoustic and language model outputs. The server then combines the recognized token sequences into text strings and associates them with start and end times derived from the frame indices. The server outputs a sequence of utterance objects for each meeting, where each utterance object contains recognized text, time boundaries, and identification information.

### Step 5

The server structures and normalizes the recognized character information.

The server receives as input the utterance objects from Step 4. The server groups tokens into utterances delimited by pauses or segment boundaries and records each grouping as a structured record. The server applies normalization operations such as removal of filler expressions, unification of punctuation, correction of obvious errors using a dictionary, and normalization of spacing. The server thereby transforms raw recognition output into cleaner, more consistent character information. The server outputs a normalized utterance list for each meeting, with each utterance represented as a text string and associated metadata.

### Step 6

The server aggregates and splits the character information according to model capacity.

The server receives as input the normalized utterance list from Step 5. The server concatenates utterances in chronological order to form an aggregated transcript string while preserving utterance boundaries and timestamps in an index structure. The server measures the length of the aggregated transcript in tokens or characters using a tokenizer compatible with the generative AI model. When the transcript length exceeds a predefined threshold corresponding to the input capacity of the generative AI model, the server splits the transcript into multiple segments at utterance boundaries. The server records for each transcript segment a segment index and the range of utterances included. The server outputs a set of transcript segments, each within the capacity limit, together with mapping information to the original utterance list.

### Step 7

The server analyzes the transcript segments to extract meeting characteristics.

The server receives as input the transcript segments from Step 6. For each segment, the server computes statistics such as number of tokens, number of utterances, and distribution of part-of-speech tags. The server applies topic analysis by embedding each utterance into a vector space using a text encoder and computing similarity between adjacent utterances to detect topic boundaries. The server identifies important terms by calculating term frequency-inverse document frequency scores, applying named entity recognition, or referencing domain-specific keyword lists. The server determines, based on these analyses, a meeting type, a set of key topics, and an occurrence status of important terms for each segment. The server outputs analysis metadata that describes length, topics, and important terms for each transcript segment.

### Step 8

The server generates a base prompt sentence from a template.

The server receives as input the analysis metadata and the transcript segments from Step 7. The server selects a prompt template appropriate to the detected meeting type and desired output style from a template repository stored on the server. The prompt template is a text pattern with placeholders. For example, the server may select a template containing the following base instruction:
“You are a tool for generating meeting minutes. Read the following meeting transcript and generate structured minutes. Include three sections: (1) Important Points, (2) Summary of Discussion, and (3) Action Items. Use clear bullet points.”

The server then inserts contextual information such as indications of important terms and target topics into the template. The server outputs a base prompt sentence that is ready for further adjustment according to segment characteristics.

### Step 9

The server dynamically adjusts the prompt sentence according to transcript characteristics.

The server receives as input the base prompt sentence and the analysis metadata from Step 8. For long segments, the server appends instructions to increase summarization level, such as “Provide a concise summary with short bullet points.” For segments with many topic changes, the server adds instructions to group content by topic, such as “Group the minutes by topic and use subheadings for each topic.” For segments with many deadlines and responsible persons, the server adds instructions such as “Explicitly list all deadlines and responsible persons under the Action Items section.” The server concatenates these additional instructions to the base prompt and, if necessary, adjusts wording to avoid contradictions. The server outputs a finalized prompt sentence for each transcript segment, which encodes the required output granularity, structure, and emphasis.

### Step 10

The server combines the prompt sentence with transcript segments for input to the generative AI model.

The server receives as input the finalized prompt sentence from Step 9 and the corresponding transcript segment from Step 6. The server constructs a model input string by concatenating the prompt sentence, a separation marker such as “Transcript:”, and the transcript segment text. The server may also insert marker tokens between utterances to preserve structure. The server then converts the model input string into token IDs using the tokenizer associated with the generative AI model. The server outputs a tokenized input sequence for each segment that is ready to be processed by the generative AI model.

### Step 11

The server executes the generative AI model to generate segment-level minutes.

The server receives as input the tokenized input sequence from Step 10. The server loads a generative AI model, implemented for example as a transformer-based neural network, from storage into memory and executes it on processing hardware such as CPUs or hardware accelerators. The server sets inference parameters including maximum output token length, temperature, and decoding algorithm. The generative AI model processes the input sequence layer by layer, computing attention scores, generating contextualized token representations, and predicting output token probabilities. The server iteratively selects output tokens based on the probabilities and the decoding algorithm to construct a text output representing minutes for the corresponding transcript segment. The server outputs generated minutes text for each segment.

### Step 12

The server assembles and structures meeting-level minutes from segment outputs.

The server receives as input the generated minutes text for each segment from Step 11. The server concatenates the segment-level minutes in the original segment order and resolves any duplicated or overlapping content by applying simple rules, for example by preferring newer segments for overlapping time ranges. The server scans the combined text to detect section labels such as “Important Points:”, “Summary of Discussion:”, and “Action Items:” produced by the generative AI model. The server splits the text at these labels and constructs a structured minutes object that includes separate lists for important items, summaries, and action items. The server outputs the structured minutes object, which is a machine-manageable representation of the meeting-level minutes.

### Step 13

The server performs document formatting and emphasis on the structured minutes.

The server receives as input the structured minutes object from Step 12. The server converts section headings and bullet lists into a standardized document format such as markup-based text, assigning heading tags to section titles and list tags to bullet items. The server applies detection rules to identify important terms, deadline expressions, and person-in-charge names in the bullet items, and it wraps these elements with emphasis markers to visually distinguish them in the final document. The server may, for example, wrap dates in a “strong” style and mark responsible persons with a label such as “Owner:”. The server outputs a formatted minutes document ready for display on a terminal.

### Step 14

The server transmits the formatted minutes to the terminal.

The server receives as input the formatted minutes document from Step 13. The server prepares a network response message containing the document and metadata such as meeting identifier and version number. The server sends the response to the terminal over a communication network using a protocol such as HTTPS. The server thereby outputs the formatted minutes to the terminal as display data.

### Step 15

The terminal displays the formatted minutes in an editable format.

The terminal receives as input the display data containing the formatted minutes from Step 14. The terminal parses the standardized document format and renders the minutes on a screen, showing the sections “Important Points,” “Summary of Discussion,” and “Action Items” with appropriate headings and bullet points. The terminal enables editing operations by allowing the user to select text, modify bullet items, insert new items, or delete existing items via input devices. The terminal outputs user interaction events and an updated local representation of the minutes as the user edits.

### Step 16

The user reviews and edits the minutes on the terminal.

The user receives as input the displayed formatted minutes from Step 15. The user reads the important points, the summary of discussion, and the action items and identifies any inaccuracies or missing information. The user directly edits text fields, for example by correcting dates, changing wording for clarity, or adding new action items. The user may, for example, change “The new product is scheduled to be launched next month.” to “The new product is scheduled to be launched on April 15.” and may add an action item such as “Prepare detailed marketing budget before April 5 (Owner: Marketing Manager).” The user outputs editing operations through keyboard and pointing device actions to the terminal.

### Step 17

The terminal generates and transmits editing results to the server.

The terminal receives as input the editing operations from Step 16 and the current local representation of the minutes. The terminal applies the editing operations to update the local minutes document and then constructs editing results that describe the updated content and, optionally, additional user instructions such as “Refine wording” or “Make summary more concise.” The terminal packages the editing results into a request message and sends the message to the server over the network. The terminal outputs the editing results as network data addressed to the server.

### Step 18

The server updates stored minutes based on the editing results.

The server receives as input the editing results from Step 17. The server parses the updated minutes content and replaces or versions the previously stored minutes document associated with the meeting identifier. The server may maintain both the original AI-generated minutes and the user-edited minutes in storage to support future comparison or learning. The server outputs an updated minutes record in the storage system and may acknowledge successful update to the terminal.

### Step 19

The server generates a regeneration prompt sentence using the edited minutes.

The server receives as input the user-edited minutes and any additional instructions included in the editing results from Step 18. The server selects a regeneration prompt template from a template repository, for example a template containing the instruction:
“Refine the following meeting minutes. Keep all factual content, but improve clarity and organization. Maintain the sections Important Points, Summary of Discussion, and Action Items.”

The server inserts the edited minutes text into the template in place of a placeholder and, if requested by the user, adds instructions such as “Shorten overly long bullet points” or “Unify tense and style.” The server outputs a regeneration prompt sentence that directs the generative AI model to reconstruct or improve the edited minutes.

### Step 20

The server refines the minutes using the generative AI model and returns the result to the terminal.

The server receives as input the regeneration prompt sentence from Step 19 and the edited minutes text. The server constructs a model input string by concatenating the regeneration prompt sentence and the edited minutes, tokenizes the input, and executes the generative AI model with parameters chosen for controlled rewriting rather than full summarization. The server obtains refined minutes as model output, post-processes them into structured sections as in earlier steps, and converts them into the standardized document format. The server then transmits the refined minutes document to the terminal for display. The server outputs refined minutes that integrate user corrections and improved organization, thereby closing the iterative refinement loop.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computerized meeting-minutes and work-log systems typically rely on either manual text entry or simple speech-to-text conversion. In such systems, a processor often performs only a direct transcription of audio into text and stores the raw text as a record. As a result, the system does not automatically extract important items, progress status, or action items, and a human operator must scan long transcripts to identify key information. This leads to increased cognitive load, latency in understanding the status of a meeting or work operation, and inconsistent quality of records.

Furthermore, in many existing architectures, any subsequent use of a generative AI model is decoupled from the speech acquisition pipeline. For example, a separate client may upload an entire transcript to a generative AI service in an ad hoc manner, without integrated context management, without structured prompt construction, and without explicit control of the generated output format. This fragmented design prevents the system from leveraging generative AI in real time and in a predictable, controllable way, and it makes it difficult to integrate generated results back into the core record-management data structures.

Still further, conventional systems generally ignore emotion information embedded in the user's speech. Even if some sentiment analysis is performed, it is often applied as an afterthought on static text and is not fed back into the generative AI model as a structured input. Consequently, the system cannot automatically emphasize emotionally significant utterances in the records or synthesize emotion-based follow-up items in a systematic manner. This leads to a loss of critical context about dissatisfaction, stress, or urgency, and reduces the effectiveness of subsequent actions taken on the basis of the records.

These limitations reflect technical shortcomings in how the processor orchestrates acquisition, analysis, prompt construction, and generative AI interaction. Specifically, the processor does not maintain time-series context that combines recognized text and emotion information, does not automatically generate and adjust prompt sentences in a structured manner, and does not control the generative AI model as an integrated subsystem of the record-generation pipeline. As a result, existing systems fail to fully utilize available computing resources to improve latency, structure, and relevance of generated records and action items.

Accordingly, there is a need for a system in which a processor is technically configured to: (i) integrate speech recognition, context management, and generative AI in a unified processing pipeline; (ii) generate structured prompt sentences that encode character information, context information, and emotion information; (iii) control a generative AI model so that it outputs structured meeting records or work records including important items, progress status, and action items; and (iv) feed the generated results back into a storage and display subsystem in substantially real time. There is also a need for the processor to technically exploit emotion information in order to emphasize relevant segments in the generated text and to synthesize prioritized follow-up items, thereby improving the functioning of the computer-based record-generation system as a whole.

The specific processing by the specific processing unit 290 of the data processing device 12 in Application Example 2 is realized by the following means.

The present invention provides a server comprising a processor configured to acquire speech information representing utterances of a user via a sound input apparatus, convert the speech information into character information using speech recognition processing based on an acoustic model and a language model, store the character information together with context information relating to a conference or a work operation in time-series form, generate a structured prompt sentence based on the stored character information and the context information, the prompt sentence being adapted to instruct a generative AI model to automatically generate at least one of meeting records and work records and to output important items, progress status, discussion summaries, and action items, input the prompt sentence to the generative AI model and obtain generated text including at least one of the meeting records and the work records, extract the important items, the progress status, and the action items from the generated text, store the extracted information in association with the at least one of the meeting records and the work records in a storage apparatus, and provide the stored at least one of the meeting records and the work records and the action items to a user terminal in substantially real time so as to be displayed in a classified manner on a display apparatus of the user terminal, and further configured to extract acoustic features and/or linguistic features from the speech information and/or the character information, recognize emotion information of the user by performing emotion estimation processing using a machine learning model, include the emotion information as part of the context information, add the emotion information to the prompt sentence so as to control input content to the generative AI model, and adjust the prompt sentence so that utterance segments corresponding to the emotion information are emphasized in the generated text and follow-up items corresponding to utterances indicating at least one of dissatisfaction, stress, anxiety, and urgency are generated as part of the action items and are displayed with priority on the user terminal. This enables an integrated computer-implemented pipeline in which the processor not only transcribes speech but also maintains time-series context, constructs and adjusts prompt sentences in a structured manner, controls the generative AI model as a functional component of the server, and exploits emotion information to automatically generate, structure, and prioritize meeting records, work records, and action items, thereby improving the technical functioning of the record-generation system in terms of automation, responsiveness, and relevance of the generated outputs.

The term “system” refers to an arrangement of hardware components and software components that cooperate to perform acquisition, processing, generation, storage, and presentation of information according to configured operations of a processor.

The term “processor” refers to a hardware computing element, such as a central processing unit or other programmable execution unit, configured to execute instructions for performing the functions described in the claims.

The term “server” refers to an information processing apparatus including at least one processor, memory, and a communication interface, configured to provide processing services such as speech recognition, context management, prompt generation, generative AI interaction, and record management to one or more terminals over a communication network.

The term “user terminal” refers to an electronic device operated by a user, such as a communication device or a computing device, including at least a display apparatus and a communication interface, and configured to send information to and receive information from the server.

The term “sound input apparatus” refers to a device such as a microphone or an array of microphones that converts acoustic signals produced by a user's utterances into electrical or digital speech information suitable for processing by the server.

The term “speech information” refers to digital data representing acoustic characteristics of a user's utterances, including at least one of raw audio samples and encoded audio data.

The term “character information” refers to text data obtained by converting speech information into a sequence of characters or symbols that represent linguistic content of the user's utterances.

The term “speech recognition processing” refers to computational processing that analyzes speech information using statistical or learned models, including at least an acoustic model and a language model, to output character information corresponding to spoken words.

The term “acoustic model” refers to a model used in speech recognition processing that relates acoustic features derived from speech information to phonetic or sub-word units.

The term “language model” refers to a model used in speech recognition processing that represents probabilities or constraints of word sequences or character sequences in one or more languages.

The term “context information” refers to metadata associated with character information, including at least one of time information, speaker information, session information, topic information, meeting information, work operation information, and emotion information, maintained in relation to a sequence of utterances.

The term “time-series form” refers to a data structure or storage format in which character information and context information are recorded in an order corresponding to occurrence time of user utterances.

The term “generative AI model” refers to a machine-learned artificial intelligence model that, in response to an input including a prompt sentence, generates text as an output using natural language generation techniques.

The term “prompt sentence” refers to an input text provided to the generative AI model, the input text including at least an instruction portion and a content portion, and specifying how the generative AI model should generate output text such as meeting records, work records, and action items.

The term “generated text” refers to text output produced by the generative AI model in response to a prompt sentence, including at least one of meeting records, work records, summaries, and lists of action items.

The term “meeting record” refers to structured text that describes content of a conference, including at least one of utterance summaries, discussion points, decisions, and follow-up tasks.

The term “work record” refers to structured text that describes content of a work operation, including at least one of instructions, progress updates, issues, and important events in an operational environment.

The term “important items” refers to pieces of information within generated text that are identified as being of higher significance, such as key decisions, critical issues, or focal points of a meeting or work operation.

The term “progress status” refers to information within generated text indicating a current state or advance of a meeting topic or work operation, including at least step completion, transition between steps, or degree of completion.

The term “discussion summaries” refers to concise descriptions of content of discussions, including main arguments, positions, and conclusions, generated from a plurality of utterances.

The term “action items” refers to concrete tasks or follow-up operations derived from meeting content or work content, including at least items specifying actions to be taken, responsible parties, and, optionally, target timing.

The term “storage apparatus” refers to a memory device or a combination of memory devices, such as semiconductor memory or magnetic storage, configured to store character information, context information, generated text, and associated metadata.

The term “display apparatus” refers to a visual output device, such as a liquid crystal display, organic light-emitting display, or similar device, configured to present text and graphical information to a user.

The term “substantially real time” refers to an operation in which processing and presentation of information are performed with a delay that is small enough not to interfere with ongoing use in a live meeting or work operation, such that the user perceives the records and action items as being updated immediately or almost immediately.

The term “acoustic features” refers to numerical values or vectors derived from speech information, such as energy, pitch, formants, spectral coefficients, prosodic patterns, or temporal statistics, that represent characteristics of the audio signal.

The term “linguistic features” refers to numerical or symbolic representations derived from character information, such as tokens, part-of-speech tags, syntactic structures, semantic vectors, or n-gram statistics.

The term “machine learning model” refers to a computational model whose parameters are learned from training data, and which is configured to perform tasks such as emotion estimation based on input features.

The term “emotion information” refers to information representing an estimated affective state of a user, including at least a label such as dissatisfaction, stress, anxiety, urgency, or neutrality, and optionally a confidence score or intensity value.

The term “emotion estimation processing” refers to processing in which a machine learning model receives acoustic features and/or linguistic features and outputs emotion information corresponding to a user's utterance.

The term “utterance segment” refers to a portion of character information or generated text corresponding to a specific temporal interval or logical unit of a user's spoken utterance.

The term “follow-up items” refers to a subset of action items generated in relation to specific utterances, especially those associated with emotion information indicating dissatisfaction, stress, anxiety, or urgency, and specifying actions intended to address such emotional or contextual conditions.

The term “classified manner” refers to a display format in which different categories of information, such as meeting records, work records, important items, progress status, and action items, are presented in visually or logically separated regions or lists.

The term “priority display” refers to a display mode in which certain items, such as follow-up items corresponding to strong emotions, are made more prominent than other items, for example by ordering, highlighting, or distinct visual styling.

In one embodiment, a server, one or more terminals, and one or more users cooperate to implement the claimed system. The server includes at least one processor, a main memory, a non-volatile storage apparatus, and a network interface. The terminals each include at least one processor, a memory, a display apparatus, a sound input apparatus such as a microphone, and a network interface. The server and the terminals are connected through a communication network such as a local area network or a wide area network.

The server executes a set of software modules including at least: a communication control module, a speech acquisition and buffering module, a speech recognition module, a context management module, an emotion estimation module, a prompt generation module, a generative AI interaction module, a post-processing and storage module, and a display control module. The terminals execute a user interface module and an audio capture and transmission module. The processor of the server is configured to execute these modules as program instructions stored in the memory and storage apparatus.

The terminal uses the sound input apparatus to convert acoustic pressure variations caused by the user's voice into analog electrical signals. The terminal then uses an analog-to-digital converter and an audio driver to obtain digital speech information, for example 16-bit linear PCM samples at a sampling rate such as 16 kHz or 48 kHz. The terminal may optionally apply noise suppression and echo cancellation using a digital signal processing library before packaging the speech information into frames of a fixed duration, such as 20 ms or 50 ms. The terminal attaches metadata such as timestamps, session identifiers, and user identifiers to each frame and transmits the frames to the server through a network protocol such as HTTPS or WebSocket over Transport Layer Security.

The server receives the speech information from multiple terminals concurrently. The server stores the received speech information into a buffer structure, for example a ring buffer indexed by timestamps and session identifiers. By using this buffer structure, the server prevents data loss in case of short-term network jitter and allows downstream modules to access contiguous sequences of speech data with deterministic latency. This buffering step contributes to stable real-time behavior and reduces the risk of incomplete segments being passed to the speech recognition module, which improves transcription accuracy and reduces the need for re-processing.

The server uses a speech recognition module that implements a hybrid model combining an acoustic model and a language model. In one embodiment, the acoustic model is a deep neural network such as a convolutional recurrent neural network that receives spectral features (for example, Mel-frequency cepstral coefficients, filter bank energies, and pitch-related features) extracted from the speech information. The server computes these features by applying a short-time Fourier transform, a Mel filter bank, and logarithmic compression, followed by mean and variance normalization per channel. The acoustic model outputs posterior probabilities of phonemes or subword units for each time frame. The language model is, for example, an n-gram model or a transformer-based model trained on large text corpora in one or more languages. The server combines the outputs of the acoustic model and the language model by a decoding algorithm such as beam search or a weighted finite-state transducer decoder to produce character information. Because the server uses these specific feature extraction methods and decoding algorithms, the server improves recognition robustness under noisy factory conditions or overlapping meeting speech, thereby reducing word error rate compared to simple heuristic decoders.

The server maintains context information in a context management module. The server stores the character information into a time-series data structure, such as an append-only log or a sequence of utterance objects, where each utterance object includes fields for text, start time, end time, speaker identifier, session identifier, and pointers to associated emotion information. The server also stores metadata describing the environment, such as “meeting topic,” “agenda item,” or “work operation identifier” and “current process step.” The server uses indexing structures such as hash tables and interval trees to quickly retrieve all utterances within a given time window or associated with a particular speaker. By maintaining this structured time-series context, the server can construct prompt sentences that incorporate only relevant portions of the transcript within the context length limit of the generative AI model, which both reduces communication payload and improves response speed.

The server uses an emotion estimation module to generate emotion information. In one embodiment, the server extracts acoustic features such as short-time energy, fundamental frequency, spectral centroid, formant trajectories, speaking rate, and voice quality measures (e.g., jitter and shimmer) from the speech information. The server also extracts linguistic features from the character information, such as token embeddings, part-of-speech tags, syntactic dependency patterns, and sentiment scores. The server concatenates these acoustic and linguistic features into feature vectors representing each utterance. The server inputs these vectors to a machine learning model, such as a multi-task neural network including bidirectional recurrent layers and fully connected layers. The model is trained to output probabilities of emotion classes such as neutral, satisfaction, dissatisfaction, anger, stress, anxiety, or urgency. During training, the server uses supervised learning with labeled audio-text pairs, a cross-entropy loss function, and gradient-based optimization such as stochastic gradient descent or Adam. The server applies regularization methods such as dropout and weight decay, as well as data augmentation for the acoustic features, for example by adding noise, changing speed, or shifting pitch, to increase robustness.

The server recognizes emotion information by executing the trained emotion model on the feature vectors. The model outputs a set of scores, for example a vector of class probabilities. The server compares each score to a threshold that may be class-specific, and the server selects one or more emotion labels whose scores exceed the threshold. The server stores the resulting emotion information as part of the context information for each utterance. Because the server uses both acoustic and linguistic features, the server can distinguish, for example, polite wording spoken with a highly stressed tone from truly neutral statements, which reduces false negatives for stress and dissatisfaction detection.

The server uses a prompt generation module to construct a prompt sentence for a generative AI model. The server retrieves from the context management module a subset of character information and emotion information relevant to the current task. The server applies a rule set or template system to determine the structure of the prompt. The rules may specify, for example, that for a meeting scenario, the server organizes the prompt into sections: a system role description, a meeting context section, a transcript snippet section, an emotion annotation section, and an output format instruction section. For a work operation scenario, the rules may specify that the prompt emphasizes process identifiers and progress status. The server executes these rules deterministically, so the generative AI model receives consistent instructions and is more likely to produce well-structured output.

In one example, when the server receives an utterance in a factory environment such as “We will proceed to the next process”, the server constructs the following prompt sentence in Japanese for the generative AI model:
“You are an AI assistant generating Japanese factory work logs.
Current work context: Line A, transitioning from Process 2 to Process 3.
Recognized utterance: “We will proceed to the next process.”
Detected emotion: neutral.
Tasks:
1. Create one concise work-log line describing that the worker is proceeding to the next process.
2. Indicate the current progress status.
Output format:
log_entry: {sentence}
progress_status: {short phrase}”

In another example, when the server detects dissatisfaction in a meeting utterance such as “I am very dissatisfied with the fact that this project is falling behind schedule”, the server constructs a prompt sentence such as:
“You are an AI assistant that generates Japanese meeting minutes and action items.
Meeting topic: Progress report on Project X.
Transcript snippet:
“I am very dissatisfied with the fact that this project is falling behind schedule.”
Detected emotion: Dissatisfaction/anger (score: 0.8).
Tasks:
1. Write a neutral minutes line summarizing this remark.
2. Add an emotion note reflecting the dissatisfaction.
3. Propose one or two concrete action items to address this dissatisfaction.
Output format:
minutes_line: . . .
emotion_note: . . .
action_items: list of bullet points.”

The server uses these non-trivial rules for prompt construction, including explicit citation of the emotion score and explicit output format labels, to reduce ambiguity and to guide the generative AI model to produce machine-parseable text. This is not a simple automation of a human summarizer's workflow; instead, the server imposes a specific, structured interface between the context management subsystem and the generative AI model, thereby improving repeatability, response time, and integration with the storage subsystem.

The server uses a generative AI interaction module to communicate with a generative AI model. In one embodiment, the generative AI model is a transformer-based language model trained on large-scale text data and fine-tuned for instruction following. The server sends the prompt sentence as part of a request message through an application programming interface. The server sets generation parameters such as maximum token length, temperature, and top-k or nucleus sampling parameters to control randomness and length of the generated text. In some embodiments, the server uses a deterministic decoding mode such as greedy decoding or low-temperature sampling to increase consistency across repeated invocations.

The server receives generated text as a response and parses the text based on the output format section of the prompt. For example, when the prompt specifies labels such as “log_entry:” or “action_items:”, the server uses these labels as markers to split the generated text into fields. The server uses simple parsing heuristics or regular expressions to locate these markers and eliminate unwanted prefixes or suffixes. The server performs normalization such as trimming whitespace, standardizing punctuation, and normalizing Japanese full-width and half-width characters. This parsing and normalization pipeline ensures that the generated text can be reliably stored and displayed and can be indexed for later search.

The server uses a post-processing and storage module to persistently store the character information, context information, generated text, important items, progress status, and action items. The server uses a relational database or a document-oriented database, with schema fields for session identifiers, timestamps, user identifiers, emotion labels, and textual content. The server creates indices on at least the session identifier and timestamp fields, enabling efficient retrieval of all records associated with a given meeting or work operation. The server may also store derived numerical metrics such as counts of dissatisfied utterances or frequency of urgent action items, which can be used for later analytics. Because the server creates structured records rather than storing only raw transcripts, the server supports fast search and aggregation operations that would be difficult or slow on unstructured text.

The server uses a display control module to send data to terminals. The server selects only the necessary portions of generated text and context information, thereby reducing communication load. For example, when a user terminal already has previous meeting records, the server transmits only newly generated minutes lines and action items, along with identifiers for ordering. The server may also attach flags indicating whether a given action item corresponds to a strong negative emotion. The server sends the data over a persistent connection such as WebSocket to achieve low-latency updates, which contribute to a substantially real-time user experience.

The terminal receives the records and renders them on the display apparatus. The terminal visually classifies information into regions such as “Meeting Summary,” “Important Items,” “Progress Status,” and “Action Items.” The terminal highlights follow-up items associated with strong emotion information by using distinct colors, icons, or ordering rules. Because the server and terminal cooperate to display prioritized items in a structured layout, a user can more quickly identify critical issues without scrolling through long text. This improves the human-computer interface and reduces the cognitive load compared to conventional flat transcript displays.

The server uses the emotion information not only for display but also for controlling the behavior of the generative AI model. When the server detects a high probability of dissatisfaction, stress, anxiety, or urgency, the server adjusts the prompt sentence by adding specific instructions such as “emphasize problems that caused dissatisfaction” or “propose follow-up actions to reduce stress.” The server may also change generation parameters, for example lowering the temperature to make outputs more deterministic in critical situations. This conditional prompt adjustment constitutes a rule-based control loop that exploits machine-estimated emotion to dynamically tune the generative AI processing. This is different from a human operator simply deciding to ask for more details; the control logic is embedded into the server and applies consistently and at scale.

From a technical standpoint, this configuration improves the functioning of the computer system. The server reduces overall processing time by: (i) streaming speech information and performing speech recognition incrementally; (ii) maintaining efficient time-series data structures and indices; and (iii) generating compact, targeted prompt sentences instead of sending entire transcripts to the generative AI model. The server improves accuracy and relevance by: (i) combining acoustic and linguistic features for emotion estimation; (ii) training a dedicated emotion model with a specific loss function and augmented data; and (iii) encoding explicit emotion labels and context in the prompt sentence. The server reduces communication load by transmitting only updated segments and by compressing context into structured instructions for the generative AI model. These specific technical mechanisms together provide more than a mere automation of human summarization; they adjust the internal flows of data and control within the server to optimize machine resources.

In another embodiment, the server uses an alternative speech recognition engine, such as one based on an end-to-end transformer encoder-decoder architecture. In such an embodiment, the server still extracts spectral features and uses positional encodings, multi-head self-attention, and feed-forward layers to map sequences of feature vectors to sequences of characters. The server trains this model with a sequence-to-sequence loss, such as a combination of cross-entropy loss and connectionist temporal classification loss. The server may then omit the explicit separate acoustic and language models but still maintains the same overall pipeline for context management, prompt generation, generative AI interaction, and emotion-based control.

In another embodiment, the server employs a different emotion estimation approach that uses only linguistic features, for situations where high-quality audio features are not available. The server uses a transformer encoder trained on text and emotion labels to compute a fixed-length embedding for each utterance and then applies a classification head to produce emotion probabilities. The server integrates this probability information into the same context and prompt generation mechanism, thereby reusing the downstream modules. This modular design allows flexible substitution of internal models without changing the overall architecture, which is beneficial for maintenance and upgrades.

In another embodiment, the server uses a different generative AI model, such as a smaller model running locally on-premises for environments with strict data privacy requirements. The server may adjust the prompt sentences to accommodate differences in model capacity by, for example, shortening context text or simplifying requested output formats. Regardless of the specific model, the server continues to control the model via structured prompt sentences that embed emotion information and contextual metadata. Thus, the technical effects of structured control and integrated context management are preserved.

In yet another embodiment, the server is configured for a pure work operation environment rather than a meeting. The server uses process identifiers from a manufacturing execution system and includes these identifiers in the context information and in the prompt sentences.

The server instructs the generative AI model to generate work records that include not only textual logs but also machine-readable tags indicating completion of specific process steps. The server then uses these tags to update databases in other systems, such as production monitoring or quality control systems, via defined application interfaces. This configuration tightly couples the generative AI processing to machine operation tracking, thereby extending the technical effects beyond information display into automatic updating of operational state.

Through these embodiments and variations, the server, the terminals, and the users cooperate to implement a system in which speech information is converted into structured records by concrete sequences of data processing steps, including specific feature extraction methods, machine-learned models, data structures, and rule-based prompt construction. The system achieves improved processing speed, accuracy, and prioritization compared to conventional systems that rely only on static transcripts or ad hoc use of generative AI. The described architecture provides a concrete technical implementation that can be realized by one of ordinary skill in the art based on the teachings herein.

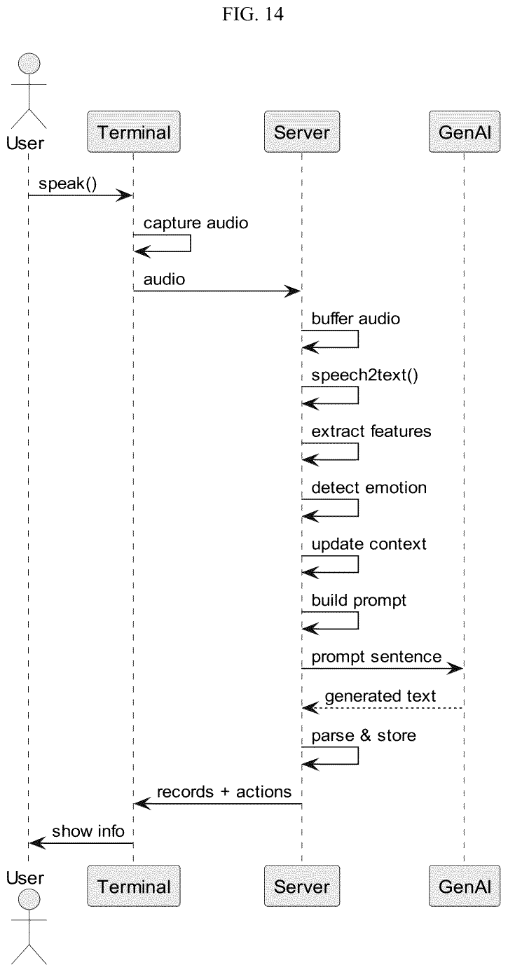

The following describes the processing flow using FIG. 14.

### Step 1

User produces an utterance.

User speaks instructions, reports, or comments in a natural voice, for example “We will proceed to the next process” or “I am very dissatisfied with the fact that this project is falling behind schedule.”

Input: no digital input (physical speech).

Output: acoustic sound waves in the air.

User generates the acoustic signal that will be captured and processed by the terminal and the server.

### Step 2

Terminal captures speech information.

Terminal uses a microphone to convert the acoustic sound waves into an analog electrical signal, and an analog-to-digital converter to sample the signal into digital speech information (e.g., 16-bit PCM at 16 kHz).

Input: acoustic sound waves from the user.

Output: a sequence of digital audio samples representing speech information.

Terminal may apply noise reduction and echo cancellation algorithms (e.g., spectral subtraction, adaptive filtering) to the digital samples, then divides the samples into fixed-length frames (for example, 20 ms per frame) and attaches metadata such as timestamp and session identifier.

### Step 3

Terminal transmits speech information to the server.

Terminal packages frames of digital speech information and associated metadata into network packets (e.g., over HTTPS or WebSocket) and sends them through a communication network to the server.

Input: framed digital speech information with metadata.

Output: network packets containing speech information delivered to the server's network interface.

Terminal maintains a send buffer and retransmission logic so that, if minor network delays occur, the terminal holds the frames until the server acknowledges receipt.

### Step 4

Server receives and buffers speech information.

Server uses a communication control module to accept incoming packets from one or more terminals, reassembles the frames, and stores the frames in an in-memory buffer indexed by session identifier and timestamp.

Input: network packets containing framed speech information and metadata.

Output: buffered speech information organized by session and time in a server memory structure.

Server appends each new frame to a ring buffer or queue and discards frames older than a configured window to maintain bounded memory usage while keeping enough context for speech recognition.

### Step 5

Server performs speech recognition and generates character information.

Server executes a speech recognition module that reads buffered speech information, computes acoustic features (such as Mel-frequency cepstral coefficients, filter-bank energies, and pitch features) for each frame, and inputs the features into an acoustic model (e.g., a deep neural network). Server combines acoustic model outputs with a language model via decoding (e.g., beam search) to produce recognized characters and words.

Input: buffered speech information in the form of digital audio frames.

Output: character information (text strings) corresponding to the user's utterances.

Server also assigns timestamps, speaker identifiers (if available), and confidence scores to each segment of character information and stores this in a time-series transcript structure.

### Step 6

Server extracts linguistic features.

Server analyzes the character information to compute linguistic features such as tokenization, part-of-speech tags, dependency relations, sentiment scores, and distributed word embeddings.

Input: character information produced by the speech recognition module.

Output: linguistic feature vectors associated with each utterance segment.

Server uses natural language processing libraries to segment sentences, assign syntactic tags, and map tokens to numeric vectors that will be used in emotion estimation.

### Step 7

Server extracts acoustic features for emotion estimation.

Server processes the same speech information to compute prosodic and voice-quality features, including frame-level energy, pitch contours, speaking rate, spectral centroid, formant trajectories, jitter, and shimmer. Server aggregates these over utterance segments to form fixed-length feature vectors.

Input: buffered speech information with time alignment to character information.

Output: acoustic feature vectors representing the paralinguistic properties of each utterance.

Server aligns acoustic frames with text segments using timestamps so that each utterance segment has a consistent set of acoustic features.

### Step 8

Server estimates emotion information.

Server inputs concatenated acoustic feature vectors and linguistic feature vectors into a trained machine learning model, such as a multi-layer neural network with recurrent or transformer layers, to compute probabilities over emotion classes (e.g., neutral, dissatisfaction, anger, stress, anxiety, urgency).

Input: combined acoustic and linguistic feature vectors per utterance.

Output: emotion information, including emotion labels and associated confidence scores.

Server compares each probability to pre-defined thresholds and selects one or more dominant emotion labels, then stores the emotion information linked to the corresponding utterance in the time-series transcript.

### Step 9

Server updates context information in time-series form.

Server maintains a context data structure that stores, in temporal order, each utterance with associated character information, timestamps, speaker identifiers, session identifiers, emotion information, and high-level session metadata (meeting topic, agenda item, work operation ID, current process step).

Input: newly generated character information and emotion information for an utterance.

Output: updated context information stored in a time-series transcript for the active session.

Server indexes these entries in a database or in-memory structure for efficient retrieval by time range, speaker, or emotional state, enabling later steps to efficiently select relevant segments.

### Step 10

Server selects relevant context segments.

Server retrieves, from the time-series context, a subset of utterances that are relevant for generating a record at a given moment, such as all utterances in the last N minutes, or within the current agenda item or process step.

Input: full time-series context information for the session and selection criteria (e.g., time window, topic segment).

Output: a condensed set of utterance segments and emotion information forming a local context.

Server applies selection rules that minimize redundancy and ensure that the total number of tokens remains within the generative AI model's context window, thus reducing computational load and latency.

### Step 11

Server constructs a prompt sentence for the generative AI model.

Server passes the selected character information, session metadata, and emotion information to a prompt generation module, which applies predetermined templates and rules to generate a structured prompt sentence tailored to the task (meeting minutes or work log).

Input: selected utterance segments, associated emotion information, and session metadata.

Output: a structured prompt sentence that includes instructions, context description, transcript snippets, emotion annotations, and output format specifications.

Server, for example, creates a prompt such as:
“You are an AI assistant that generates Japanese meeting minutes and action items.
Meeting topic: Progress report on Project X.
Transcript snippet:
“I am very dissatisfied with the fact that this project is falling behind schedule.”
Detected emotion: Dissatisfaction/anger (score: 0.8).
Tasks:
1. Write a neutral minutes line summarizing this remark.
2. Add an emotion note reflecting the dissatisfaction.
3. Propose one or two concrete action items to address this dissatisfaction.
Output format:
minutes_line: . . .
emotion_note: . . .
action_items: list of bullet points.”

### Step 12

Server sends the prompt sentence to the generative AI model.

Server uses a generative AI interaction module to transmit the prompt sentence to a generative AI model (for example, a transformer-based language model). Server sets generation parameters such as maximum output length, temperature, and sampling strategy and issues a request through an application programming interface.

Input: prompt sentence and generation parameters.

Output: a request message delivered to the generative AI model and, upon completion, a raw generated text response.

Server waits for the response, handles network errors or timeouts, and retries the request if necessary within configured limits.

### Step 13

Server obtains and parses generated text.

Server receives the generated text from the generative AI model and parses the text according to markers specified in the prompt sentence (e.g., “minutes_line:”, “log_entry:”, “action_items:” labels).

Input: raw generated text from the generative AI model.

Output: structured components such as meeting records, work records, important items, progress status entries, and lists of action items.

Server applies parsing rules, regular expressions, and normalization operations (such as trimming whitespace, standardizing punctuation, and normalizing character forms) to ensure that each output field is cleanly separated and machine-readable.

### Step 14

Server extracts important items, progress status, and action items.

Server examines the structured components of the generated text and identifies entries classified as important items, progress status updates, and action items based on the labels and content.

Input: structured generated text segmented into labeled fields.

Output: specific objects representing important items, progress status entries, and action items associated with the session.

Server converts these textual components into structured records, for example objects with fields such as “type,” “description,” “related_utterance_ids,” and “emotion_tags,” enabling efficient storage and later retrieval.

### Step 15

Server associates generated records with context and emotion information.

Server links each generated meeting record or work record, and each action item, to the corresponding utterance segments and emotion information using identifiers and timestamps.

Input: generated record objects and the existing time-series context.

Output: enriched records that include references to original utterances and stored emotion labels.

Server, for example, attaches a reference to the utterance where strong dissatisfaction was detected to an action item recommending a follow-up meeting, allowing future analysis of how emotional states influenced generated actions.

### Step 16

Server stores records and metadata in a storage apparatus.

Server writes the generated meeting records or work records, along with associated important items, progress status, action items, and emotion-linked references, into a persistent storage system such as a database.

Input: enriched records containing text fields and metadata.

Output: stored database entries indexed by session identifier, timestamp, and type.

Server creates and updates indices to enable fast queries by criteria such as “all urgent action items in the last hour” or “all records where stress was detected,” improving retrieval performance and enabling technical analytics.

### Step 17

Server prepares an update payload for terminals.

Server selects newly generated or updated records that have not yet been sent to each user terminal, composes an update payload that includes only those new elements, and adds display hints such as priority flags for emotion-based follow-up items.

Input: stored records and a record of what each terminal has already received.

Output: a compact update message tailored for each terminal.

Server compresses the payload if necessary and uses identifiers so that terminals can merge the new data with previously displayed content without duplications, thereby reducing communication load and improving responsiveness.

### Step 18

Server sends records and action items to terminals.

Server transmits the update payload to one or more user terminals via a low-latency communication channel such as WebSocket or server-sent events, ensuring that new information reaches the terminals with minimal delay.

Input: update payload containing meeting records, work records, important items, progress status, and action items with display hints.

Output: network messages delivered to user terminals.

Server may prioritize messages that include urgent action items or high-intensity emotion flags, sending them before lower-priority updates to improve reaction time for critical issues.

### Step 19

Terminal receives and renders updated information.

Terminal receives the update messages, parses the data fields, and updates the user interface by inserting new records into appropriate sections, such as “Meeting Summary,” “Work Log,” “Important Items,” “Progress,” and “Action Items.”

Input: network messages containing structured record data and display hints.

Output: updated visual content presented on the display apparatus.

Terminal orders items chronologically and highlights items marked as high-priority (for example, those associated with dissatisfaction, stress, anxiety, or urgency) with distinct colors or icons, allowing the user to immediately identify critical content.

### Step 20

User reviews and reacts to displayed information.

User reads the meeting records or work records, important items, progress status, and action items on the display apparatus and decides on subsequent actions, such as ordering a process change, scheduling a follow-up meeting, or providing additional instructions to workers.

Input: visually rendered records and action items on the terminal.

Output: human decisions and physical or digital follow-up actions outside the system's automatic processing.

User may also provide manual feedback or corrections via the terminal (e.g., editing a record or marking an action item as completed), and the terminal sends these updates back to the server, where they are stored and incorporated into the ongoing context.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

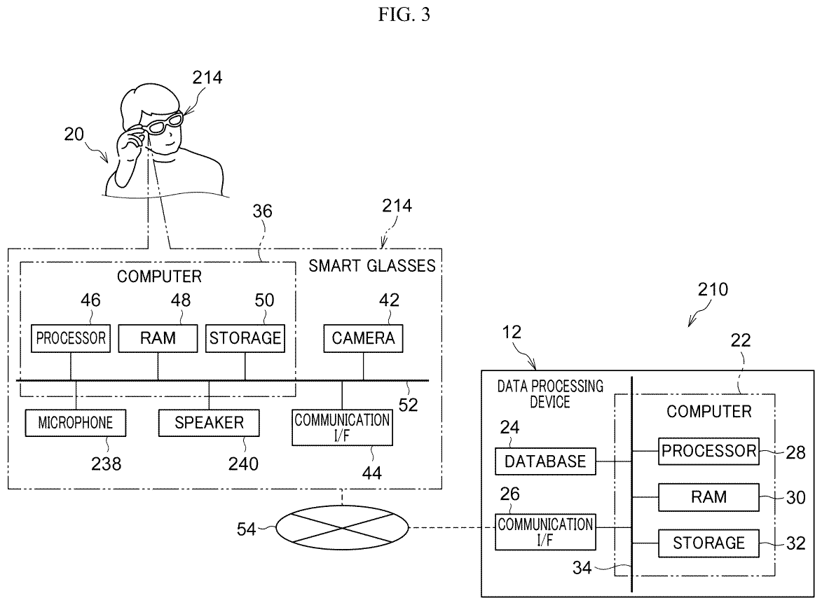

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

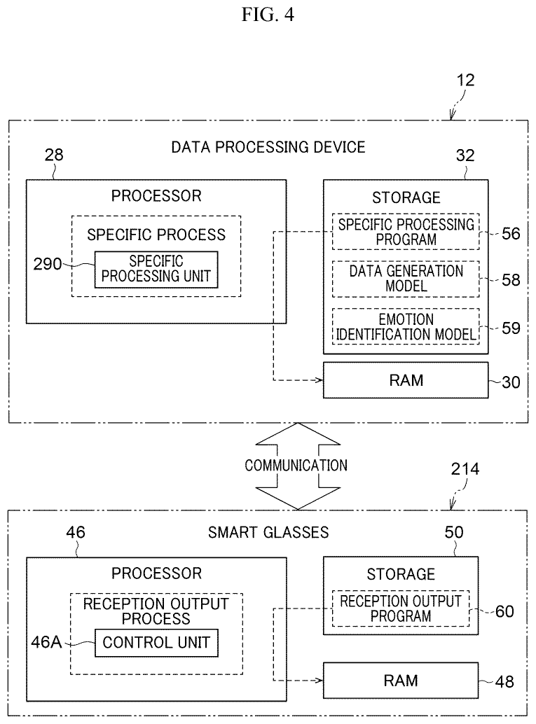

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

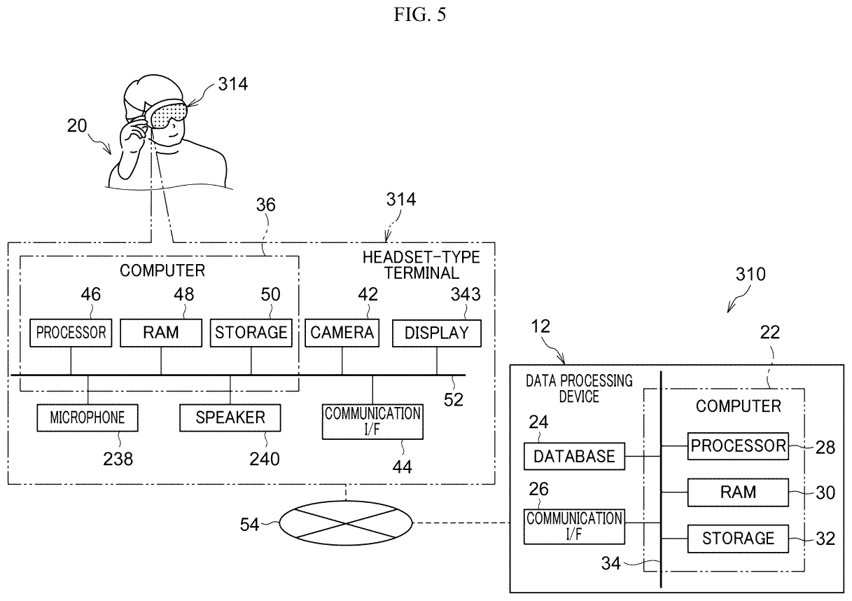

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

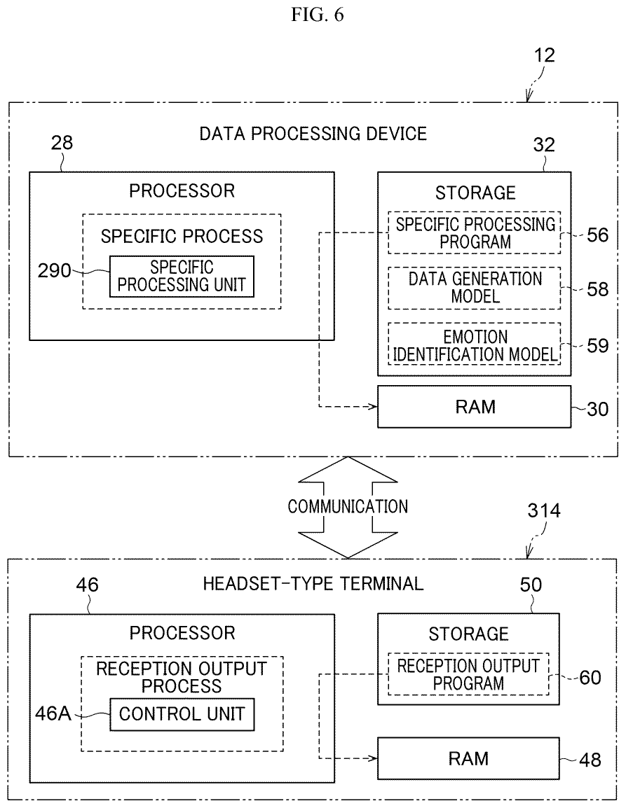

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

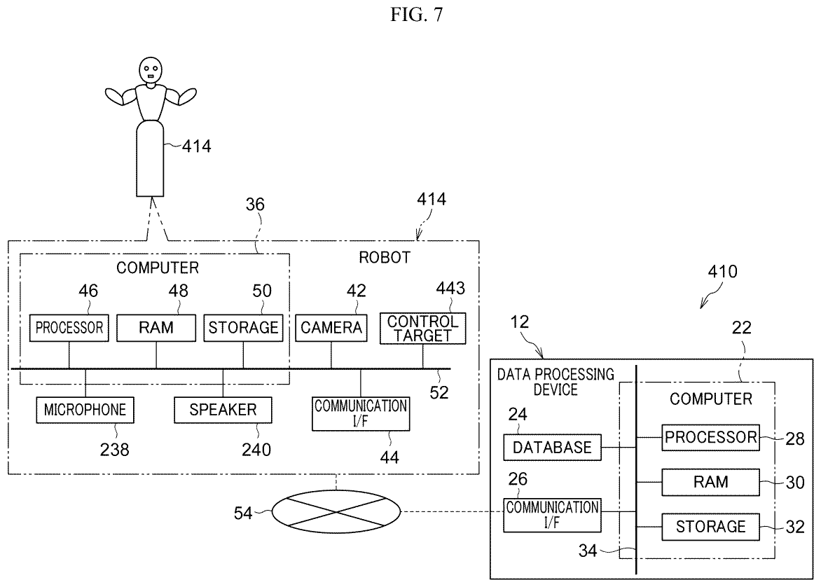

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

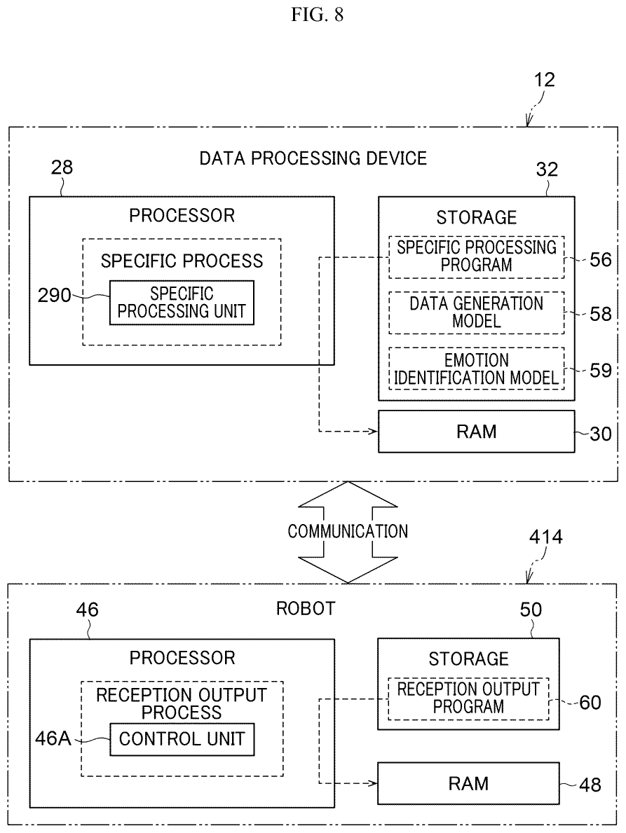

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

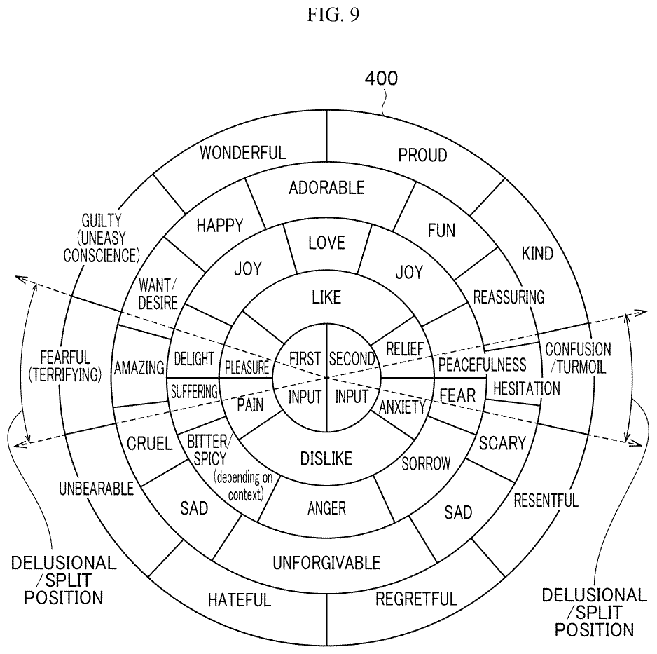

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

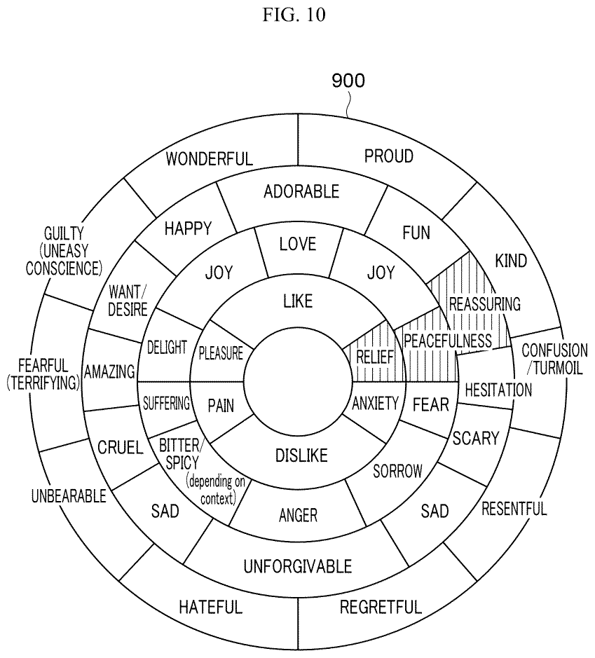

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire audio information of utterances of meeting participants by using an audio acquisition unit comprising an audio input device,
convert the acquired audio information into character information in a plurality of languages by using a speech recognition unit including a speech recognition processing unit that supports a plurality of languages,
accumulate the character information obtained by the speech recognition unit in time series order, and generate meeting-record text on an agenda basis or on a time-segment basis in accordance with progress of a meeting by using a text management unit,
generate, by using a prompt generation unit, a prompt sentence including the meeting-record text generated by the text management unit and instruction content regarding a summary of the meeting, decision items, action items, and a document format,
transmit, by using a generation instruction unit, the prompt sentence generated by the prompt generation unit to a generative information processing model disposed externally or internally, and cause the generative information processing model to generate a minutes document based on the meeting-record text sequentially or at predetermined intervals,
store and update, by using a minutes management unit, the minutes document generated by the generative information processing model in accordance with the progress of the meeting, and transmit the minutes document to a display device or an output device,
extract, by using an emotion recognition unit, feature values of the audio information acquired by the audio acquisition unit, and estimate an emotional state of at least one of the meeting participants by using a trained discrimination model,
and provide, by using a prompt adjustment unit, the estimated emotional state to the prompt generation unit and adjust content of the prompt sentence in accordance with the emotional state so as to perform a summary, emphasis of important points, and proposal of action items based on the emotional state.

### Supplementary 2

The system according to supplementary 1,
wherein the processor is configured to
cause the generation instruction unit to generate, by the prompt generation unit, a prompt sentence for generating a final version of the minutes document on the basis of character information of an entire meeting accumulated by the text management unit at an end of the meeting, and to input the prompt sentence into the generative information processing model so that the generative information processing model generates an integrated minutes document including a summary, agenda-wise organization, decision items, and action items.

### Supplementary 3

The system according to supplementary 1,
wherein the processor is configured to
cause the minutes management unit to accept an editing operation for the minutes document by a user, store an edited minutes document in association with the text management unit as reference information for future prompt sentence generation for the generative information processing model, and improve, on the basis of the reference information, contents of summaries and proposals of action items in a subsequent meeting.

Application Example 1

### Supplementary 1

A system comprising a processor,
wherein the processor is configured to
acquire speech of a worker as audio data by using an audio input device, convert the audio data into text data by using a speech recognition function that performs acoustic processing and character string conversion processing,
generate a prompt sentence for a generative AI model based on the text data and a recording format for work in a production facility, the prompt sentence instructing the generative AI model to automatically generate work record data,
input the prompt sentence and the text data into the generative AI model to cause the generative AI model to generate structured work record data including date-time information, production line information, work content information, and result information,
add user identification information, terminal identification information, processing time information, and equipment identification information to the work record data to convert the work record data into log data for progress management and quality management as recording data, and
store the log data in an information storage device and, in response to an acquisition request from a management display device, acquire and output the log data.

### Supplementary 2

The system according to supplementary 1,
wherein the processor is configured to
generate a prompt sentence for the generative AI model with respect to a set of the log data stored in the information storage device, the prompt sentence instructing the generative AI model to automatically generate summary information and aggregation information, and
cause the generative AI model to generate a summary report of work status and a summary report of quality trends and output the summary reports to the management display device.

### Supplementary 3

The system according to supplementary 1,
wherein the processor is configured to
perform an estimation process that extracts audio feature quantities from the audio data and estimates state information of the worker, adjust the prompt sentence to be input to the generative AI model based on the state information, and cause the generative AI model to generate work record data and action item proposal information reflecting the state information.

### Example 2

### Supplementary 1

A system comprising a processor,
wherein the processor is configured to
collect audio information by using an audio acquisition device to capture speech of meeting participants, and to divide the audio information into time-based segments while assigning identification information to each segment and storing the segments, and
input the audio information to a speech recognition processing function, and convert the audio information into character information corresponding to a plurality of languages by using an acoustic model and a language model, and structure and store the character information on a unit basis of utterances, and
aggregate the character information, perform a normalization process to remove unnecessary utterance elements, and perform a splitting process to divide long character information according to an input capacity of a generative AI model, and
generate a prompt sentence by selecting a predefined prompt template based on the divided character information and a meeting type, the prompt sentence instructing generation of minutes including an output format of the minutes, important items, a summary of discussion, and action items, and
input the prompt sentence and the character information to the generative AI model, and cause the generative AI model to automatically generate the minutes and acquire the minutes divided into sections of the important items, the summary of discussion, and the action items, and
convert the acquired minutes into a predetermined document format by using a document generation processing function, and format the minutes by assigning headings to the sections and emphasizing important terms, deadline information, and person-in-charge information, and
transmit the formatted minutes to a terminal device and present the formatted minutes in an editable display format on the terminal device, and
receive editing results input from the terminal device and update and store the minutes based on the editing results.

### Supplementary 2

The system according to supplementary 1,
wherein the processor is configured to
generate a regeneration prompt sentence, based on edited minutes and additional instructions transmitted as the editing results from the terminal device, the regeneration prompt sentence instructing the generative AI model to reconstruct or improve expressions of the edited minutes, and input the regeneration prompt sentence and the edited minutes to the generative AI model to acquire refined minutes, and re-present the refined minutes to the terminal device.

### Supplementary 3

The system according to supplementary 1,
wherein the processor is configured to
adjust contents of the prompt sentence such that an output granularity, a summarization level, and a section structure in the prompt sentence are dynamically changed according to a length of the character information, a change of topics, and an occurrence status of important terms included in the character information, and provide the adjusted prompt sentence to the generative AI model.

### Application Example 2

### Supplementary 1

A system comprising a processor,
wherein the processor is configured to
acquire speech information representing utterances of a user by using a sound input apparatus connected to an information processing apparatus, and transmit the acquired speech information to the information processing apparatus via a communication path,
convert the speech information into character information by performing speech recognition processing using an acoustic model and a language model, and store the character information together with context information relating to a conference or a work operation in time-series form,
generate a prompt sentence, based on the stored character information and the context information, the prompt sentence being for instructing a generative artificial intelligence model to automatically generate at least one of meeting records and work records and to output important items, progress status, discussion summaries, and action items,
input the prompt sentence to the generative artificial intelligence model and obtain generated text from the generative artificial intelligence model, the generated text including at least one of the meeting records and the work records,
extract the important items, the progress status, and the action items from the generated text and store the important items, the progress status, and the action items in association with the at least one of the meeting records and the work records in a storage apparatus, and
provide the stored at least one of the meeting records and the work records and the action items to a user terminal in substantially real time and cause the at least one of the meeting records and the work records and the action items to be displayed in a classified manner on a display apparatus of the user terminal.

### Supplementary 2

The system according to supplementary 1,
wherein the processor is configured to
extract at least one of acoustic features and linguistic features from at least one of the speech information and the character information, recognize emotion information of the user by performing emotion estimation processing using a machine learning model, include the emotion information as part of the context information stored in time-series form, and add the emotion information to the prompt sentence so as to control input content to the generative artificial intelligence model.

### Supplementary 3

The system according to supplementary 1,
wherein the processor is configured to
adjust the prompt sentence so that, in the generated text obtained from the generative artificial intelligence model, utterance segments corresponding to the emotion information are emphasized in description, and cause the generative artificial intelligence model to generate, as at least part of the action items, follow-up items corresponding to utterances indicating at least one of dissatisfaction, stress, anxiety, and urgency based on the emotion information, and cause the follow-up items to be displayed with priority on the user terminal.

What is claimed is:

1. A system comprising:
circuitry configured to:
receive, via a communication interface coupled to a packet-switched network, audio data from a terminal device;
convert the audio data into text data in a plurality of languages using an acoustic model and a language model;
analyze the text data and generate a natural-language prompt sentence for a transformer-based generative neural network model to generate structured output data, the structured output data comprising at least highlighted items, summary text, and task entries; and
transmit, via the communication interface coupled to the packet-switched network, the structured output data to the terminal device for rendering on a display of the terminal device.

2. The system according to claim 1, wherein the circuitry is further configured to:
segment the audio data into a plurality of time-based audio segments and associate each audio segment with identification information comprising at least a session identifier, a segment index, and a timestamp.

3. The system according to claim 2, wherein the circuitry is further configured to:
extract, from each audio segment, acoustic feature vectors by applying at least one of a short-time Fourier transform, a Mel-frequency cepstral coefficient computation, and a log-Mel filter bank operation to sampled audio frames of the audio segment.

4. The system according to claim 3, wherein converting the audio data into the text data comprises:
inputting the acoustic feature vectors to the acoustic model implemented as a deep neural network to compute posterior probability distributions over phonetic units; and
executing a decoding algorithm comprising beam search using the posterior probability distributions and probabilities from the language model to generate a sequence of utterance objects, each utterance object comprising recognized text, a start time, and an end time.

5. The system according to claim 4, wherein the circuitry is further configured to:
normalize the recognized text by removing filler expressions, unifying punctuation, correcting recognition errors using a dictionary-based replacement, and compressing repetitive phrases detected by analyzing n-gram frequencies.

6. The system according to claim 5, wherein the circuitry is further configured to:
measure a length of the text data in tokens using a tokenizer compatible with the transformer-based generative neural network model; and
when the measured length exceeds a threshold corresponding to an input capacity of the transformer-based generative neural network model, split the text data into a plurality of transcript segments at utterance boundaries while preserving a mapping between each transcript segment and an original utterance order.

7. The system according to claim 1, wherein the circuitry is further configured to:
extract audio feature quantities from the audio data and input the audio feature quantities to an emotion estimation neural network classifier to compute a probability distribution over a set of emotion categories; and
select a dominant emotion category from the set of emotion categories based on the probability distribution.

8. The system according to claim 7, wherein the circuitry is further configured to:
adjust the natural-language prompt sentence based on the dominant emotion category so as to instruct the transformer-based generative neural network model to generate structured output data that reflects an emotional context indicated by the dominant emotion category.

9. The system according to claim 8, wherein the emotion estimation neural network classifier receives as input at least one of pitch contour values, energy statistics, speaking rate values, and Mel-frequency cepstral coefficient features extracted from the audio data, and outputs the probability distribution via a softmax output layer.

10. The system according to claim 9, wherein adjusting the natural-language prompt sentence comprises:
when the dominant emotion category indicates a high-stress state, inserting an instruction into the natural-language prompt sentence to include explicit safety-related task entries and to increase a level of detail in the summary text; and
when the dominant emotion category indicates a neutral or positive state, maintaining a default summarization level in the natural-language prompt sentence.

11. The system according to claim 1, wherein analyzing the text data comprises:
computing semantic similarity between consecutive utterance segments using vector representations generated by a neural text encoder to detect topic boundary points where the semantic similarity falls below a threshold; and
identifying important terms by computing term-frequency inverse-document-frequency scores and applying named entity recognition to the text data.

12. The system according to claim 11, wherein generating the natural-language prompt sentence comprises:
selecting a prompt template from a template repository stored in a non-transitory storage medium based on a detected meeting type; and
inserting into the prompt template the text data, indications of the important terms, and instructions specifying an output granularity and a summarization level adjusted based on a length of the text data and a number of detected topic boundary points.

13. The system according to claim 12, wherein the structured output data comprises meeting minutes including at least highlighted important points of a meeting, summaries of discussions organized by detected topics, and action items comprising task descriptions, assignee identifiers, and deadline information.

14. The system according to claim 13, wherein the circuitry is further configured to:
post-process the structured output data by detecting section labels within inference output of the transformer-based generative neural network model, splitting the inference output at the detected section labels, and converting each section into a standardized document format with heading tags, list structures, and emphasis markers applied to deadline expressions and assignee identifiers.

15. The system according to claim 14, wherein the circuitry is further configured to:
receive, from the terminal device via the communication interface, editing results comprising user modifications to the structured output data and additional user instructions; and
generate a regeneration prompt sentence by inserting the editing results and the additional user instructions into a regeneration prompt template, supply the regeneration prompt sentence to the transformer-based generative neural network model, and acquire refined structured output data incorporating the user modifications.

16. The system according to claim 15, wherein the circuitry is further configured to:
store, in a non-transitory storage medium, a first version of the structured output data generated by the transformer-based generative neural network model and a second version of the structured output data incorporating the user modifications, with version information enabling retrieval of both versions.

17. The system according to claim 16, wherein the audio data comprises utterances of meeting participants captured by a microphone of the terminal device, and wherein the task entries comprise action items derived from the meeting including task descriptions, responsible person identifiers, and deadline dates.

18. A system comprising:
circuitry configured to:
receive, via a communication interface coupled to a packet-switched network conforming to at least one of a 5G, Wi-Fi, or Bluetooth communication standard, audio data from a terminal device comprising a microphone, a display, and an input device;
segment the audio data into a plurality of time-based audio segments and extract acoustic feature vectors from each audio segment by applying a Mel-frequency cepstral coefficient computation;
convert the audio data into text data in a plurality of languages by inputting the acoustic feature vectors to an acoustic model implemented as a deep neural network and executing a beam search decoding algorithm using a language model;
extract audio feature quantities from the audio data and input the audio feature quantities to an emotion estimation neural network classifier to compute a dominant emotion category;
analyze the text data by computing semantic similarity between utterance segments to detect topic boundaries and by identifying important terms using term-frequency inverse-document-frequency scores and named entity recognition;
generate a natural-language prompt sentence by selecting a prompt template from a template repository, inserting the text data, indications of important terms, and the dominant emotion category into the prompt template, and adjusting a summarization level based on a length of the text data and a number of detected topic boundaries;
supply the natural-language prompt sentence to a transformer-based generative neural network model comprising a stack of self-attention layers and feed-forward layers, and acquire structured output data comprising highlighted items, summary text organized by topic, and task entries with assignee identifiers and deadline information;
post-process the structured output data into a standardized document format with heading tags, list structures, and emphasis markers; and
transmit the structured output data to the terminal device via the communication interface coupled to the packet-switched network for rendering on the display of the terminal device.

19. The system according to claim 18, wherein the circuitry is further configured to:
receive editing results from the terminal device comprising user modifications to the structured output data, generate a regeneration prompt sentence incorporating the editing results, supply the regeneration prompt sentence to the transformer-based generative neural network model, and acquire refined structured output data incorporating the user modifications.

20. A method comprising:
receiving, by circuitry via a communication interface coupled to a packet-switched network, audio data from a terminal device;
converting, by the circuitry, the audio data into text data in a plurality of languages using an acoustic model and a language model;
analyzing, by the circuitry, the text data and generating a natural-language prompt sentence for a transformer-based generative neural network model to generate structured output data, the structured output data comprising at least highlighted items, summary text, and task entries; and
transmitting, by the circuitry, via the communication interface coupled to the packet-switched network, the structured output data to the terminal device for rendering on a display of the terminal device.
